(19) United States
(12) Patent Application Publication
(10) Pub. No.: US 2006/0118247 A1
(43) Pub. Date: Jun. 8, 2006

(54) Furnishing accessory and methods of assembling and installing same

(75) Inventors: Michael Olsen, Frisco, TX (US); Brett Curtin, Phoenix, AZ (US); Matthew Weiss, Highland Village, TX (US)

Correspondence Address: HAYNES AND BOONE, LLP, 901 MAIN STREET, SUITE 3100, DALLAS, TX, 75202, US

(73) Assignee: Trade Source International, Inc., Coppell, TX (US)

(21) Appl. No.: 11/286,120

(22) Filed: Nov. 22, 2005

Related U.S. Application Data
(60) Provisional application No. 60/633,787, filed on Dec. 7, 2004.

(51) Int. Cl. E04F 10/00; E06B 9/00

(52) U.S. Cl. 160/38

(57) ABSTRACT

A furnishing accessory and methods of assembling and installing same are described.

### CROSS-REFERENCE TO RELATED APPLICATION

This application claims the benefit of the filing date of U.S. provisional patent application No. 60/633,787, filed Dec. 7, 2004, the disclosure of which is incorporated by reference.

### BACKGROUND

Furnishing accessories such as, for example, cornice boxes, mantels, valance boards, window sills or other furnishings or accents, are sometimes employed inside or outside of houses, vehicles or other structures for functional and/or decorative purposes. For example, a cornice box may be installed above a window, a mantel may be built around a fireplace, or a storage unit, shelving unit or window sill may be placed in a room or vehicle.

However, several issues arise in connection with the use of furnishing accessories. A typical furnishing accessory sometimes must be a custom, one-of-a-kind piece, or must be significantly modified or customized, in order to accommodate the room or space in which the furnishing accessory is to be installed, the physical dimensions or functional features thereof, and/or the furniture and/or equipment placed therein. In addition to physical or functional limitations, decorative or aesthetic considerations are also sometimes important. For example, it may be desirable for the furnishing accessory to appear as if it is a custom piece, specifically designed and built for the space in which the furnishing accessory is to be placed.

The functional and/or aesthetic considerations associated with the furnishing accessory may increase the complexity of the fabrication or assembly of the furnishing accessory, the overall cost of the furnishing accessory, and/or the lead time necessary to manufacture and/or obtain the furnishing accessory. Moreover, the installation of the furnishing accessory may be complex and/or time consuming, especially when the furnishing accessory is to be installed in a highly-customized setting.

Further, a desire to decrease lead times in connection with providing furnishing accessories may result in the up-front fabrication of furnishing accessories having different sizes, configurations and/or dimensions, thereby increasing up-front costs, overall storage needs and inventory costs.

Therefore, what is needed is a furnishing accessory, and/or a method of assembling and/or installing a furnishing accessory, that overcomes one or more of the above-described problems, among others.

### BRIEF DESCRIPTION OF THE DRAWINGS

FIG. 1 is a perspective view of a furnishing accessory according to an embodiment.

FIG. 2 is an exploded view of the furnishing accessory of FIG. 1.

FIG. 3 is another exploded view of the furnishing accessory of FIG. 1.

FIG. 4 is a partial perspective/partial sectional view of a portion of the furnishing accessory of FIG. 1.

FIG. 5A is a partial perspective view of another portion of the furnishing accessory of FIG. 1 but depicting additional components engaged therewith.

FIG. 5B is an elevational view of the furnishing accessory of FIG. 1 but depicting another operational mode.

FIG. 6A is a perspective view of an alternate embodiment of one of the additional components depicted in FIG. 5A.

FIG. 6B is a sectional view of the alternate embodiment of FIG. 5A.

FIG. 7 is a perspective view of a furnishing accessory according to another embodiment.

FIG. 8 is an exploded view of the furnishing accessory of FIG. 7.

FIG. 9 is a perspective view of a furnishing accessory according to yet another embodiment.

FIG. 10 is a perspective view of a portion of the furnishing accessory of FIG. 9.

FIGS. 11A-11D are elevational views that depict different embodiments of the portion of FIG. 10.

FIG. 12 is a perspective view of a portion of a furnishing accessory according to yet another embodiment.

FIG. 13 is a perspective view of a portion of a furnishing accessory according to yet another embodiment.

FIG. 14 is a perspective view of a portion of a furnishing accessory according to yet another embodiment.

FIG. 15 is a perspective view of a furnishing accessory according to yet another embodiment.

FIG. 16 is an exploded view of the furnishing accessory of FIG. 15.

FIG. 17 is an exploded view of a portion of the furnishing accessory of FIG. 15.

FIG. 18 is an exploded view of a furnishing accessory according to yet another embodiment.

FIG. 19 is a perspective view of a furnishing accessory according to yet another embodiment.

FIG. 20 is an exploded view of the furnishing accessory of FIG. 19.

FIG. 21 is a perspective view of a furnishing accessory according to yet another embodiment.

FIG. 22 is an exploded view of the furnishing accessory of FIG. 21.

FIG. 23 is a perspective view of a furnishing accessory according to yet another embodiment.

FIG. 24 is an exploded view of the furnishing accessory of FIG. 23.

FIG. 25 is an enlarged view of a portion of the furnishing accessory of FIG. 23 but depicting an additional component engaged therewith.

FIG. 26 is a partially exploded perspective view of a furnishing accessory according to yet another embodiment.

FIG. 27 is a perspective view of a furnishing accessory according to yet another embodiment.

FIG. 28 is an exploded view of the furnishing accessory of FIG. 27.

### DETAILED DESCRIPTION

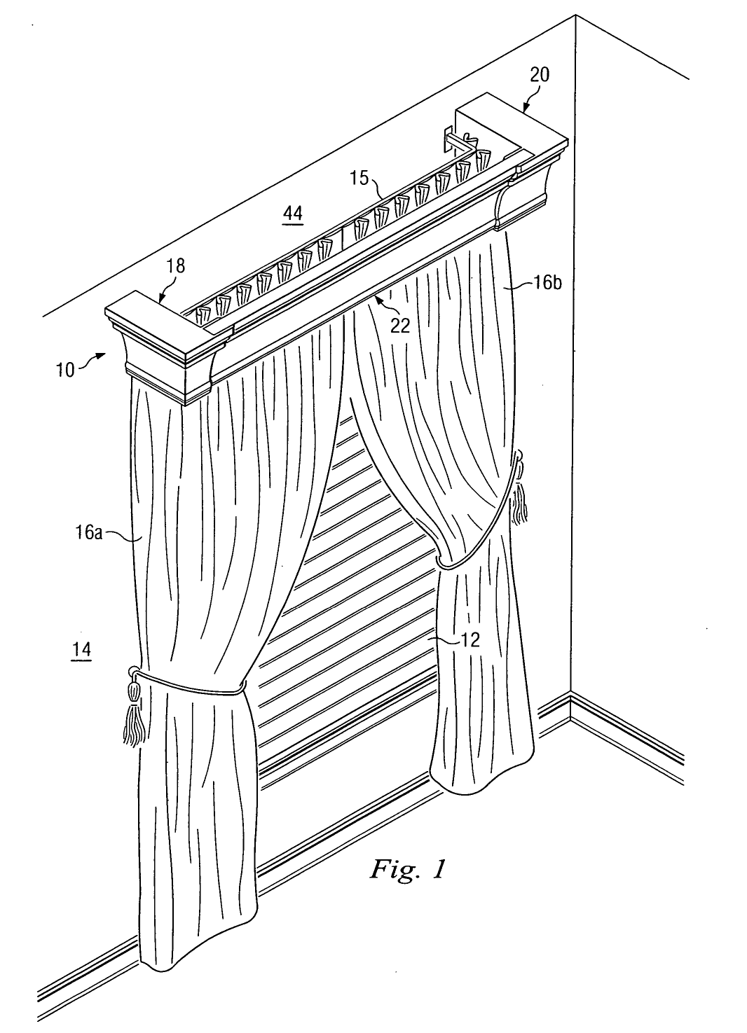

Referring to FIG. 1, a furnishing accessory, in the form of a cornice box, is generally referred to by the reference numeral 10. A window 12 is formed in a wall 14. The cornice box 10 is positioned over the window 12 and conceals a rod 15 and the tops of a set of drapes 16a and 16b. A pair of joint elements or endcaps 18 and 20 are connected to the wall 14, and a design element, in the form of a protrusion or valance 22, extends between and is engaged with the endcaps.

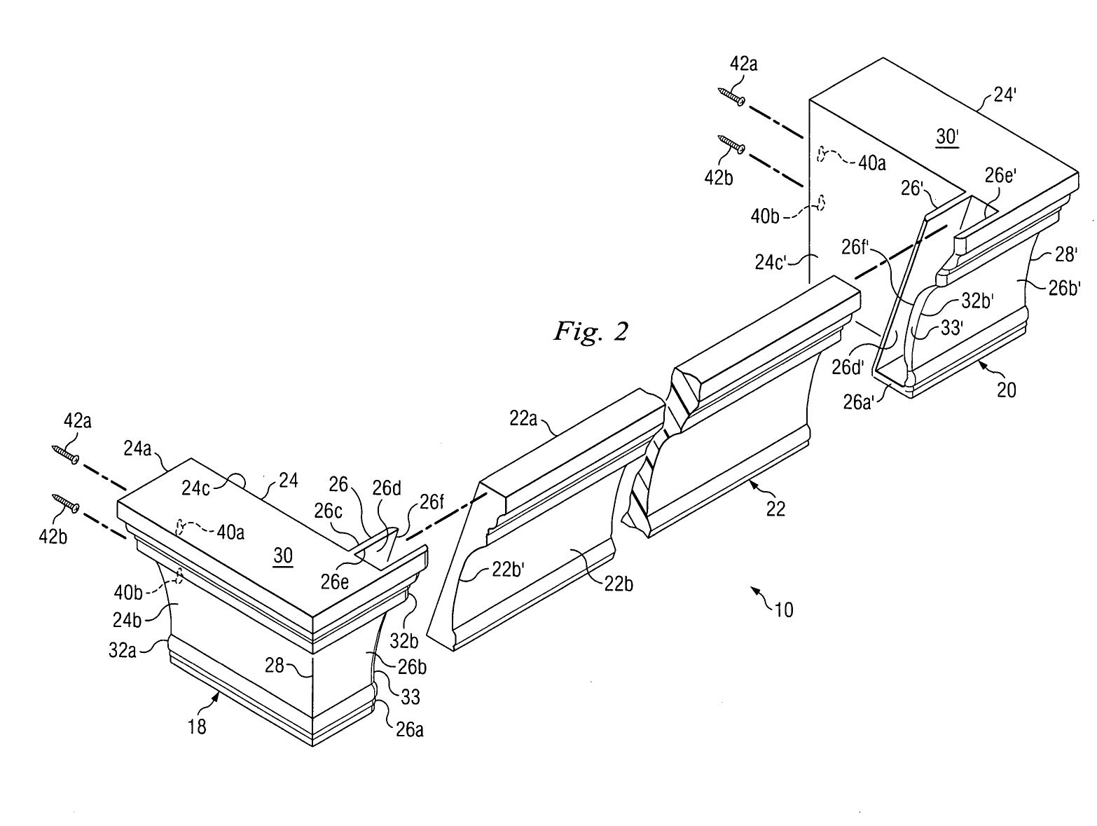

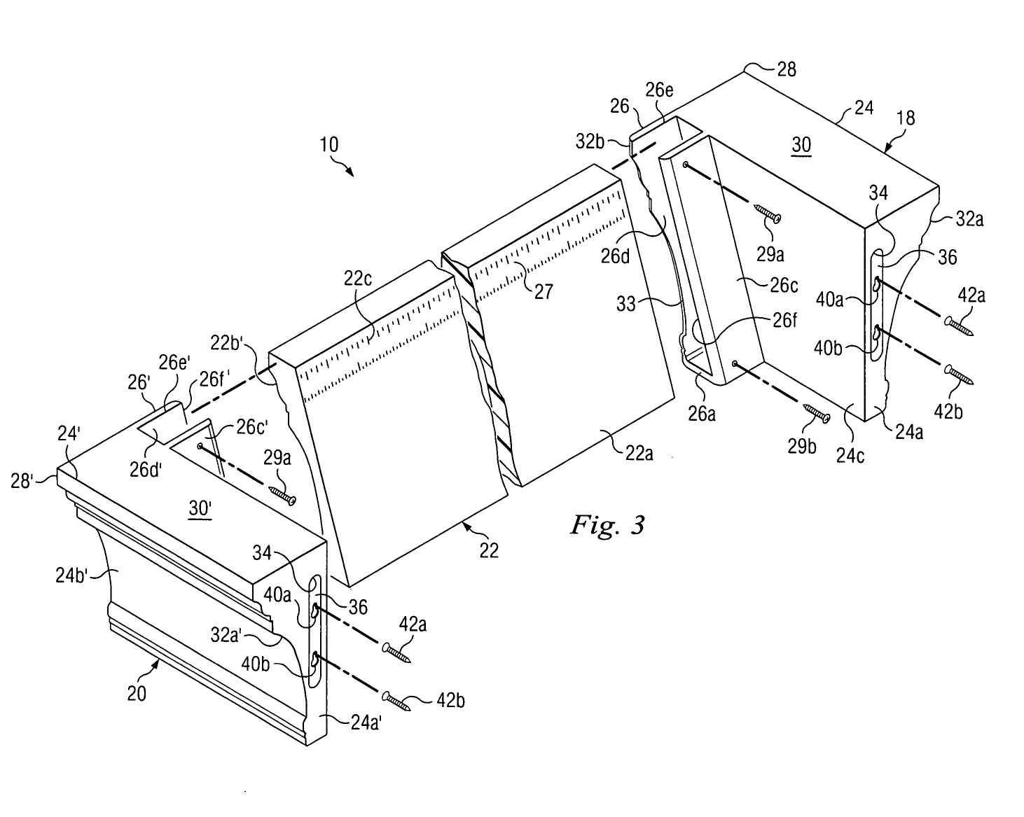

Referring to FIGS. 2-3, with continuing reference to FIG. 1, the endcap 18 includes a rearward-extending protrusion 24. A transversely-extending protrusion 26 extends from the protrusion 24, forming a corner 28. The protrusion 24 includes a rear surface 24a, an outer surface 24b and an inner surface 24c. Similarly, the protrusion 26 includes an end surface 26a, an outer surface 26b and an inner surface 26c. The inner surface 26c is adapted to receive fasteners 29a and 29b under conditions to be described. A top surface 30 is shared by both of the protrusions 24 and 26. The end surface 26a angles from the top surface 30 toward the protrusion 24.

Decorative profiles 32a and 32b are defined by the outer surfaces 24b and 26b, respectively, so that the lines defined by the profiles are substantially continuous across the corner 28, being broken only by the edge defined by the corner.

A pocket 26d is formed in the distal end of the protrusion 26 having an upward opening 26e defined in the top surface 30 and a side opening 26f defined in the end surface 26a. A round 33 is formed in the endcap 18, and provides a curved transition from the outer surface 26b to an edge of the opening 26f in the end surface 26a. The profile of the edge of the opening 26f adjacent the round 33, and the cross-section of the wall of the pocket 26d extending therefrom, correspond to the decorative profile 32b.

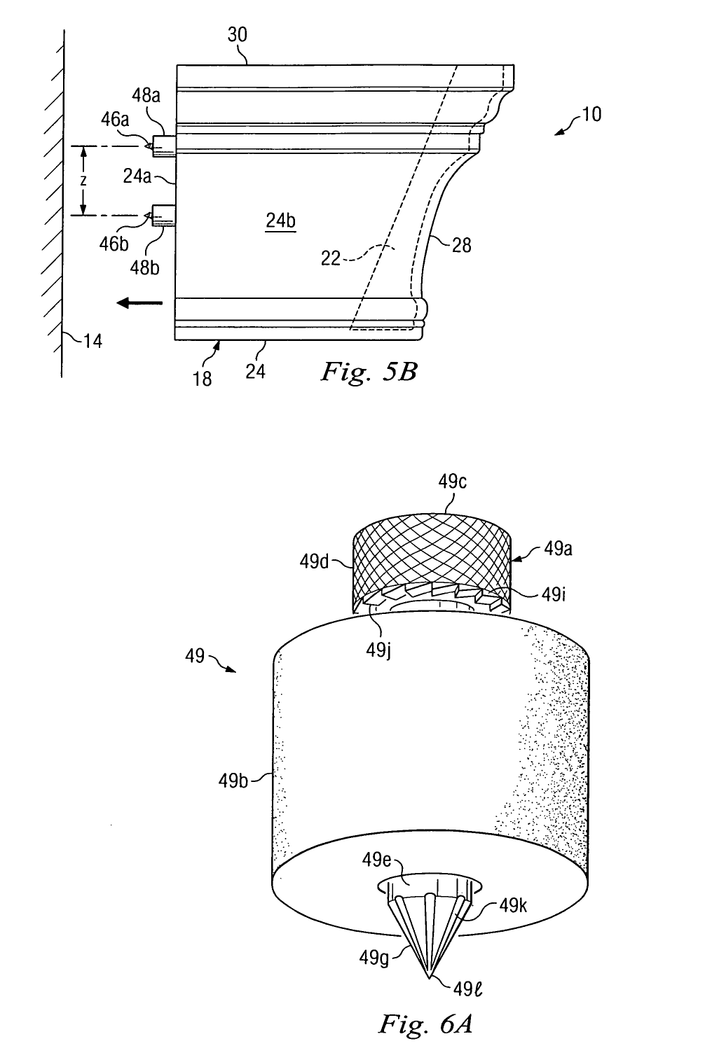

A blind slot 34 is formed in the rear surface 24a and a bracket 36 is fixed therein. Linearly-aligned keyhole slots 40a and 40b are formed through the bracket 36 and are substantially aligned with openings formed in the interior surface of the slot 34 (openings shown in FIG. 5A), thereby associating the keyhole slots with the rear surface 24a. Installation members such as fasteners 42a and 42b extend from the wall 14 and are adapted to engage the keyhole slots 40a and 40b, respectively, in a conventional manner to secure the endcap 18 against the wall.

The valance 22 is angularly oriented from its upper surface to its inner surface toward the wall 14, and includes an inner surface 22a and an outer surface 22b, with a profile 22b′ defined by the decorative profile 32b. Further, the cross-section of the valance 22 corresponds with the cross-section of the pocket 26d, with respect to the pocket's extension from the end surface 26a and towards the protrusion 24. A plurality of measurement markings 27 are printed or formed on the inner surface 22a of the valance 22.

The endcap 20 is the symmetric equivalent to the endcap 18 and therefore will not be described in detail. Parts of the endcap 20 that are identical to parts of the endcap 18 are given the same reference numerals, whereas parts of the endcap 20 that are the symmetric equivalents to parts of the endcap 18 are also given the same reference numerals, but with prime designations.

When the cornice box 10 is in its installed condition, the keyhole slots 40a and 40b of each endcap 18 and 20 are engaged with and supported by the corresponding fasteners 42a and 42b, respectively, so that the endcaps are secured against the wall 14, with at least portions of the rear surfaces 24a and 24a′ offset from or contacting the wall. An end portion of the valance 22 is slidably engaged with and received by the pocket 26d, and the opposing end portion of the valance is slidably engaged with the pocket 26d′.

The fasteners 29a and 29b extend through the inner surface 26c and into the end portion of the valance 22 engaged with the pocket 26d, thereby removably securing the valance 22 to the endcap 18. Likewise, the other set of fasteners 29a and 29b extend through the inner surface 26c′ and into the end portion of the valance engaged with the pocket 26d′, thereby removably securing the valance 22 to the endcap 20.

It is understood that the fasteners 29a and 29b are optional and that their absence from the cornice box 10 does not substantially compromise the integrity of the engagement between the valance 22 and the endcap 18, and between the valance 22 and the endcap 20. That is, with or without the fasteners 29a and 29b, the valance 22 is held in place by the pockets 26d and 26d′. Moreover, the walls of the pockets 26d and 26d′ prevent the valance 22 from moving in a direction towards or away from the wall 14, relative to the endcaps 18 and 20, and vice versa. It is understood that the degree of movement of the valance 22 in any direction is dependent upon the presence of gaps between the valance and the walls of the pockets 26d and 26d′.

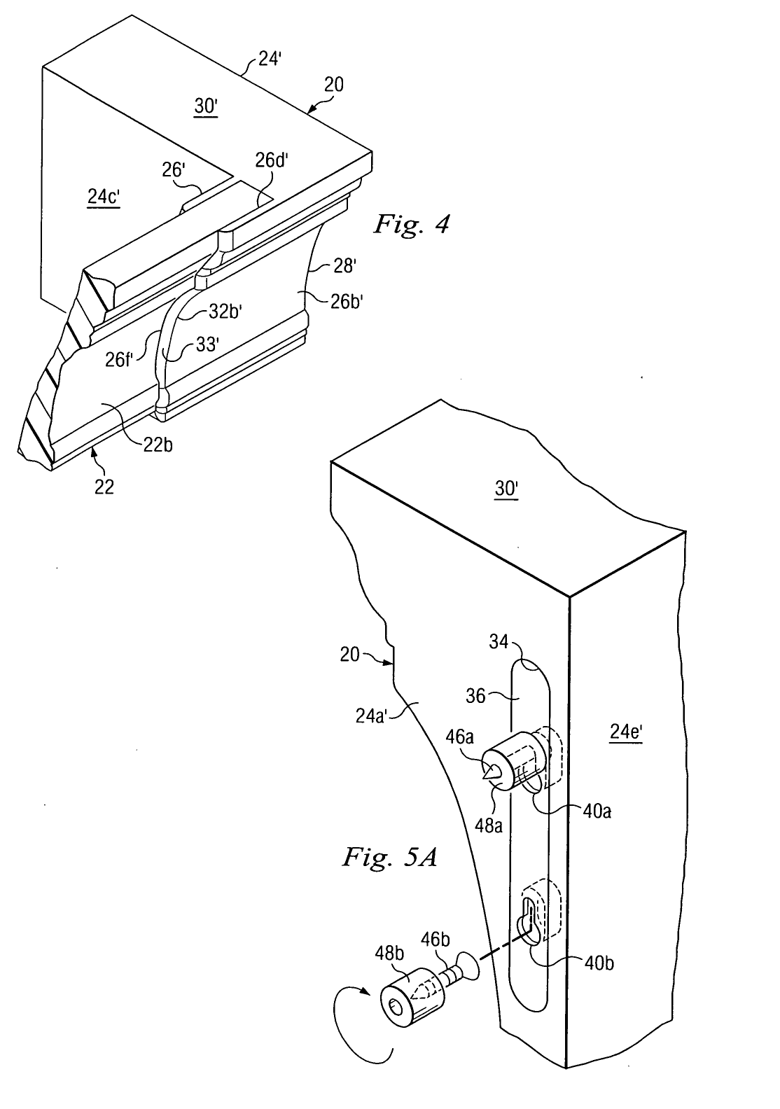

As more clearly shown in FIG. 4, the end portion of the valance 22 extends into the pocket 26d′ so that the profile of the outer surface 22b appears to be continuous with the decorative profile 32b′ formed in the outer surface 26b′ of the endcap 20. The round 33′ promotes this appearance of continuity and serves to further suggest that the endcap 20 and the valance 22 are integrally formed. The angular orientations of the valance 22, and of the corresponding profile of the opening 26f′, further promote the appearance of continuity and integral formation between the valance and the endcap 22. The engagement of the valance 22 with the endcap 18 is equivalent with the foregoing.

Due to the connection of the endcaps 18 and 20 to the wall 14, and the extension of the valance 22 between the endcaps, a volume 44 (FIG. 1) is defined by the wall 14 and the inner surfaces 24c, 26c, 22a, 26c′ and 24c′.

In operation, the tops of the drapes 16a and 16b, the rod 15, and any other associated hardware used to support and/or suspend the drapes 16a and 16b, are disposed in the volume 44 and concealed from view by the endcaps 18 and 20 and the valance 22. The decorative profiles 32a, 32b, 32a′, 32b′, and the profile 22b′ on the outer surface 22b of the valance 22 aesthetically enhance the window 12, the wall 14, the drapes 16a and 16b and/or the surrounding environment.

To assemble the cornice box 10, it is understood that the length of the valance 22 may be reduced as desired such as, for example, in cases where the length of the valance is appreciably greater than the width of the window 12. The measurement markings 27 indicate the length of the valance 22. To reduce the length of the valance 22, the valance may be cut at any location therealong, with the cutting plane substantially perpendicular to the extension of the measurement markings 27 which, in turn, may be used to indicate the amount of material being cut and/or the length of the remaining uncut portion of the valance.

An end portion of the valance 22 is inserted and slid into the corresponding opening 26f of the pocket 26d, and the fasteners 29a and 29b are driven through the inner surface 26c and into the end portion of the valance, thereby removably securing the valance to the endcap 18. Likewise, the opposing end portion of the valance 22 is inserted and slid into the corresponding opening 26f of the pocket 26d′, and the fasteners 29a and 29b are driven through the inner surface 26c′ and into the end portion of the valance, thereby removably securing the valance to the endcap 20. It is understood that the opposing end portions of the valance 22 may be inserted into the pockets 26d and 26d′ before driving any of the fasteners 29a or 29b into the valance or, as discussed above, use of the fasteners 29a and 29b may be omitted.

It is understood that, if one or more portions of the valance 22 have been cut off to reduce the length of the valance, as described above, the extension of the valance into the pockets 26d and 26d′ conceals from view any physical indications that the valance has been cut, thereby preserving the overall aesthetics of the cornice box 10.

To install the cornice box 10, it is desired to form pilot indentations such as pilot holes in the wall 14 corresponding to the eventual positions of the fasteners 42a and 42b. To this end, and referring to FIGS. 5A and 5B with continuing reference to FIGS. 1-4, pilot members such as pilot fasteners 46a and 46b are provided, which extend through grommets 48a and 48b, respectively, which can be clamped into the bracket 36 as will now be described.

As shown in FIG. 5A for the endcap 20, once the grommet 48a is threaded onto the pilot fastener 46a, the head of the pilot fastener 46a is inserted into the increased-diameter portion of the keyhole slot 40a, and slid upwards in the slot. The spacing between the head of the pilot fastener 46a and the grommet 48a is set so that the grommet 48a does not interfere with the upward movement of the pilot fastener within the keyhole slot 40a. The distal end of the pilot fastener 46a is then pulled in a direction perpendicularly away from the bracket 36, causing the head of the pilot fastener to bear against the back side of the bracket 36. In this condition, the grommet 48a is then further threaded onto the pilot fastener 46a towards the bracket 36 (since the pilot fastener 46a is prevented from rotating due to the friction with the back side of the bracket) until the grommet bears against the front side of the bracket 36, that is, against the material surrounding the slot 40a, thereby clamping the pilot fastener 46a in place relative to the slot 40a and the bracket. It is understood that the grommet 48a may have internal threads that correspond with the external threads on the extension portion of the pilot fastener 46a, thereby facilitating the movement of the grommet along the extension portion due to this threaded engagement. In a manner identical to the foregoing and using the grommet 48b, the pilot fastener 46b is clamped in place, relative to the slot 40b and the bracket 36, so that the centerlines of the pilot fasteners 46a and 46b are vertically spaced by a distance z (shown in FIG. 5B).

In the above-described manner, corresponding pilot fasteners 46a and 46b and grommets 48a and 48b are also clamped to the bracket 36 of the endcap 18. With each pair of pilot fasteners 46a and 46b clamped in place, the cornice box 10 is moved to the orientation with respect to the window 12 and the rod 15 that the user wants it to ultimately reside, and it is then translated horizontally and towards the wall 14, as indicated by the direction of the arrow shown in FIG. 5B. Due to this movement, the distal ends of each pair of pilot fasteners 46a and 46b are pushed into the wall until the end surfaces of the grommets 48a and 48b of each endcap 18 and 20 contact the wall 14, forming two pairs of indentations in the wall. The indentations in each pair of indentations are vertically spaced by the distance z and mark the proper placement for the fasteners 42a and 42b.

Each pair of fasteners 42a and 42b are then connected to the wall 14 in any conventional manner at the corresponding locations of the indentations so that portions of the fasteners 42a and 42b extend out from the wall and are vertically spaced by the distance z. It is understood that the fasteners 42a and 42b are substantially linearly aligned due to the linear alignment of the keyhole slots 40a and 40b, and the corresponding linear alignment of the pilot fasteners 46a and 46b when the pilot fasteners are clamped to the bracket 36.

The pairs of pilot fasteners 46a and 46b are removed from the keyhole slots 40a and 40b, respectively, by performing the above-described clamping procedure in reverse. The cornice box 10 is then positioned so that the keyhole slots 40a and 40b of the endcap 18 engage and are supported by the corresponding fasteners 42a and 42b, respectively, in a conventional manner, and at least a portion of the rear surface 24a contacts and/or is positioned near the wall 14. Further, the keyhole slots 40a and 40b of the endcap 20 engage and are supported by the corresponding fasteners 42a and 42b, respectively, in a conventional manner, and at least a portion of the rear surface 24a′ contacts and/or is positioned near the wall 14. Thus, the cornice box 10 is removably connected to the wall 14.

It is understood that the relatively easy engagement between each pair of the keyhole slots 40a and 40b and each corresponding pair of the fasteners 42a and 42b is possible because the vertical spacing between any position along the keyhole slot 40a and any position along the keyhole slot 40b is substantially equal to the distance z, that is, the vertical spacing between the fasteners 42a and 42b. Further, the horizontal spacing between the pairs of keyhole slots 40a and 40b is substantially equal to the horizontal spacing between the pairs of fasteners 42a and 42b. Thus, the endcaps 18 and 20 are easily connectable to the wall 14.

It is understood that the pilot fastener 46a and the grommet 48a, and/or the pilot fastener 46b and the grommet 48b, may constitute a kit or a portion of a kit.

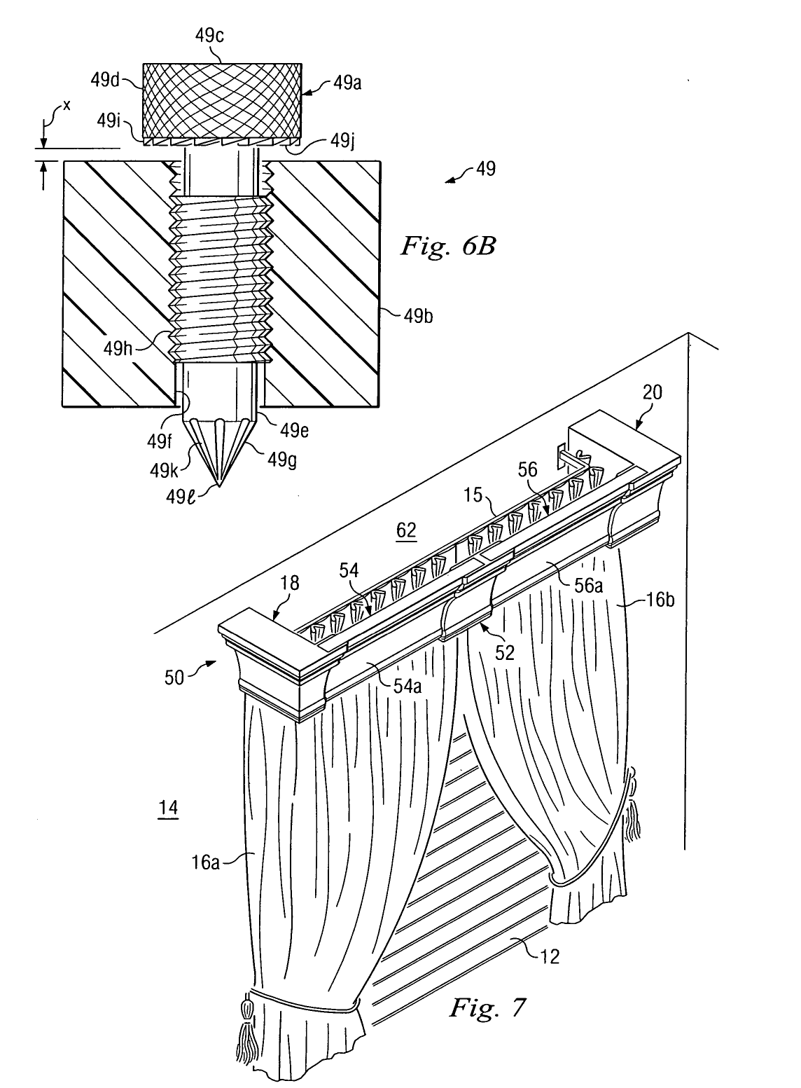

Referring to FIGS. 6A and 6B, a pilot assembly is generally referred to by the reference numeral 49 and includes a pilot fastener 49a extending through a grommet 49b. The pilot fastener 49a includes a head portion 49c having a circumferentially-extending knurled surface 49d, and an extension portion 49e axially extending from the head portion and through a bore 49f formed through the grommet 49b, the extension portion having a cone-shaped distal end portion 49g and an external threaded connection 49h threadably engaged with the grommet.

A plurality of radially-extending ribs 49i extends from the head portion 49c and towards the grommet 49b, with each rib being generally wedge-shaped and having a distal end 49j. It is understood that the distal ends 49j of the ribs 49i are generally coplanar so that an axial spacing x is defined between the grommet 49b and the distal ends of the ribs. A plurality of grooves 49k are formed in and extend along the distal end portion 49g, with each groove meeting the other grooves at a pointed end 491 of the distal end portion.

The axial spacing x is adjustable since it is understood that the head portion 49c is adapted to axially translate towards or away from the grommet 49b, in response to the clockwise rotation or the counterclockwise rotation, respectively, of the pilot fastener 49a. Moreover, it is understood that, in response to the clockwise rotation of the pilot fastener 49a, the threaded connection 49h may form an internal threaded connection in the grommet 49b, and/or may increase the axial length of any existing internal threaded connection in the grommet. It is further understood that the knurled surface 49d enables an operator to easily grip the head portion 49c and rotate the pilot fastener 49a, thereby facilitating the adjustment of the axial spacing x. It is understood that the axial spacing x may be adjusted so that the axial spacing x is only slightly larger than the thickness of the bracket 36. Also, it is understood that the pilot assembly 49 may constitute a kit or a portion of a kit.

In operation, it is understood that the pilot assembly 49 may be substituted for the pilot fastener 46a and the grommet 48a, and/or the pilot fastener 46b and the grommet 48b, during the installation of the cornice box 10. If one or more such substitutions are made, it is further understood that the installation of the cornice box 10, using one or more pilot assemblies 49, is substantially identical to the above-described installation of the cornice box using the pilot fasteners 46a and 46b and the grommets 48a and 48b.

During and after the clamping of the pilot assembly 49 to the corresponding bracket 36, one or more of the distal ends 49j of the ribs 49i at least partially penetrate and/or create an indentation in the back side of the bracket, gripping the bracket to facilitate the clamping engagement between the pilot assembly and the bracket, thereby maintaining as substantially constant the position of the pilot assembly relative to the bracket before, during and after the above-described formation of pilot indentations or holes in the wall 14.

During the formation of each pilot indentation or hole in the wall 14, the grooves 49k cause a generally star-shaped imprint to be formed in the portion of the wall surrounding the pilot indentation or hole, thereby facilitating the identification of the pilot indentation or hole in order to properly locate the connection location between the wall and the fastener 42a or 42b.

In addition to, or instead of, the foregoing, it is understood that the cornice box 10 may be installed in any conventional manner.

Referring to FIG. 7, another embodiment of a furnishing accessory, in the form of a cornice box, is generally referred to by the reference numeral 50. The embodiment shown in FIG. 7 is similar to the embodiment shown in FIGS. 1-6 and contains several parts of the embodiment which are given the same reference numerals. In the embodiment of FIG. 7, a joint element 52 is disposed between the endcaps 18 and 20. A design element, in the form of a protrusion or valance 54, extends between and is engaged with the endcap 18 and the joint element 52, and a design element, in the form of a protrusion or valance 56, extends between and is engaged with the joint element 52 and the endcap 20.

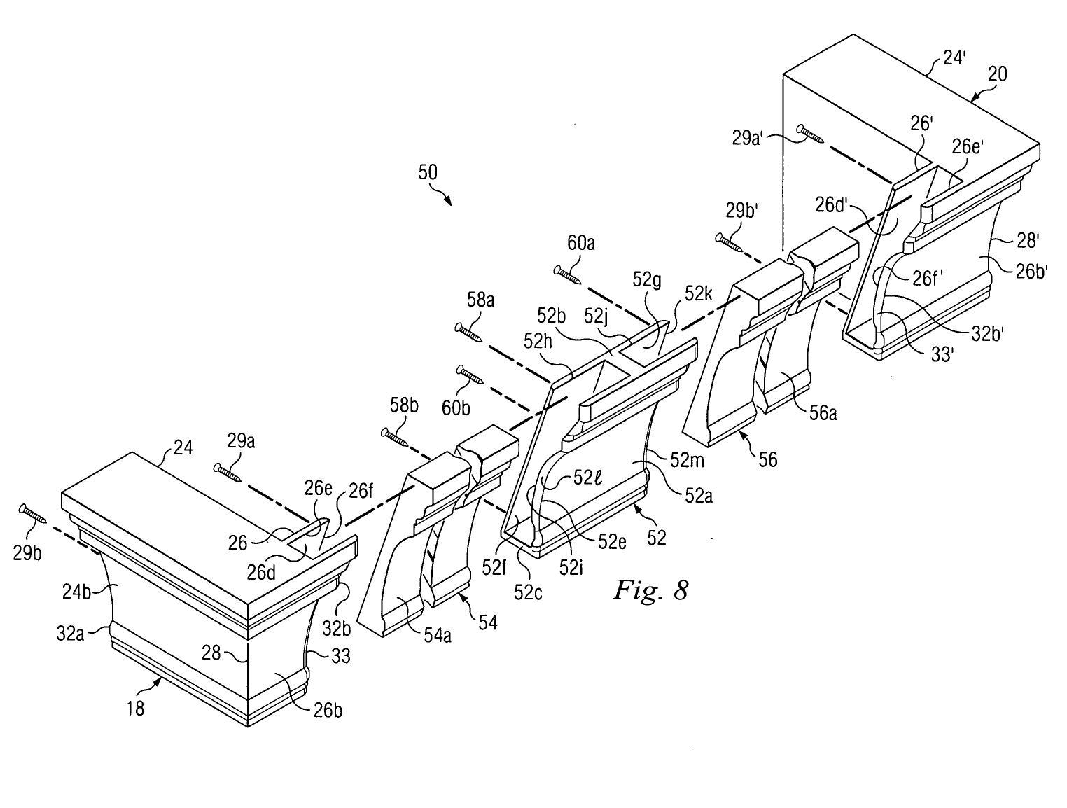

Referring to FIG. 8, the joint element 52 includes a protrusion having an outer surface 52a, a top surface 52b and opposing end surfaces 52c and 52d (end surface 52d not shown). A decorative profile 52e is defined by the outer surface 52a and is substantially equivalent to the decorative profiles 32b and 32b′ of the endcaps 18 and 20, respectively.

Opposing pockets 52f and 52g are formed in the joint element 52, with the pocket 52f extending downwards from the top surface 52b to define an opening 52h, and extending inwards from the end surface 52c to define an opening 52i. Similarly, the pocket 52g extends downwards from the top surface 52b to define an opening 52j, and extends inwards from the end surface 52d to define an opening 52k. The joint element 52 is angled so that the joint element extends in both a downward and rearward direction.

A round 521 is formed in the joint element 52, providing a curved transition from the outer surface 52a to an edge of the opening 52i on the end surface 52c. Similarly, a round 52m is formed in the joint element 52, providing a curved transition from the outer surface 52a to an edge of the opening 52k on the end surface 52d. The profiles of the edges of the openings 52i and 52k adjacent the rounds 521 and 52m, respectively, and the cross-section of the walls of the pockets 52f and 52g extending from the end surfaces 52c and 52d, respectively, correspond to the decorative profile 52e.

The valance 54 is angularly oriented from its upper surface to its lower surface toward the wall 14 and includes an outer surface 54a with a profile defined by the decorative profiles 52e and 32b. Likewise, the valance 56 is angularly oriented from its upper surface to its lower surface toward the wall 14 and includes an outer surface 56a with a profile defined by the decorative profiles 52e and 32b′. Further, the cross-sections of the valances 54 and 56 correspond with the cross-sections of the pockets 52f and 52g, with respect to the pockets' extension from the end surfaces 52c and 52d, respectively. It is understood that measurement markings similar to the measurement markings 27 may be printed or formed on the inner surfaces of the valances 54 and 56.

When the cornice box 50 is in its installed condition, the keyhole slots 40a and 40b of each endcap 18 and 20 are engaged with and supported by the corresponding fasteners 42a and 42b, respectively, so that the endcaps are secured against the wall 14, with at least portions of the rear surfaces 24a and 24a′ contacting or slightly offset from the wall. An end portion of the valance 54 is slidably engaged with the pocket 26d of the endcap 18, and the opposing end portion of the valance is slidably engaged with the pocket 52f of the joint element 52. An end portion of the valance 56 is slidably engaged with the pocket 52g of the joint element 52, and the opposing end portion of the valance is slidably engaged with the pocket 26d′ of the endcap 20.

The fasteners 29a and 29b extend through the inner surface 26c and into the end portion of the valance 54 engaged with the pocket 26d, thereby removably securing the valance 54 to the endcap 18. Fasteners 58a and 58b extend through the inner surface of the joint element 52 and into the end portion of the valance 54 engaged with the pocket 52f, thereby removably securing the valance 54 to the joint element 52. Fasteners 60a and 60b extend through the inner surface of the joint element 52 and into the end portion of the valance 56 engaged with the pocket 52g, thereby removably securing the valance 56 to the joint element 52. The other set of fasteners 29a and 29b extend through the inner surface 26c′ and into the end portion of the valance 56 engaged with the pocket 26d′, thereby removably securing the valance 56 to the endcap 20.

It is understood that the fasteners 29a and 29b are optional and that their absence from the cornice box 50 does not substantially compromise the integrity of the engagement between the valance 54 and the endcap 18, and between the valance 56 and the endcap 20, for the same reasons discussed above in connection with the valance 22 and the endcaps 18 and 20 of the embodiment of FIGS. 1-6.

Similarly, it is understood that the fasteners 58a, 58b, 60a and 60b are optional and that their absence from the cornice box 50 does not substantially compromise the integrity of the engagement between the valance 54 and the joint element 52, and between the valance 56 and the joint element. That is, with or without the fasteners 58a, 58b, 60a and 60b, the valances 54 and 56 are held in place by the pockets 52f and 52g.

Moreover, the walls of the pockets 52f and 52g prevent the valances 54 and 56, respectively, from moving in a direction towards or away from the wall 14, relative to the joint element 52, and vice versa. It is understood that the degree of movement of the valance 54 in any direction is dependent upon the presence of gaps between the valance and the walls of the pockets 26d and 52f. Similarly, it is understood that the degree of movement of the valance 56 in any direction is dependent upon the presence of gaps between the valance and the walls of the pockets 52g and 26d′.

An end portion of the valance 54 extends into the pocket 52f so that the profile of the outer surface 54a appears to be continuous with the decorative profile 52e formed in the outer surface 52a of the joint element 52 (shown in FIG. 7). The round 521 promotes this appearance of continuity and serves to further suggest that the joint element 52 and the valance 54 are integrally formed. The angular orientations of the valance 54, and of the corresponding profile of the opening 52i, further promote the appearance of continuity and integral formation between the valance and the joint element 52.

The engagement of the opposing end portion of the valance 54 with the pocket 26d of the endcap 18 is similar to the engagement between the valance 22 and the pocket 26d described above in connection with the embodiment of FIGS. 1-6 and therefore will not be described in detail. The decorative profile 32b of the endcap 18 appears to be continuous with the decorative profile of the outer surface 54a of the valance 54.

An end portion of the valance 56 extends into the pocket 52g so that the profile of the outer surface 56a appears to be continuous with the decorative profile 52e formed in the outer surface 52a of the joint element 52. The round 52m promotes this appearance of continuity and serves to further suggest that the joint element 52 and the valance 56 are integrally formed. The angular orientations of the valance 56, and of the corresponding profile of the opening 52k, further promote the appearance of continuity and integral formation between the valance and the joint element 52.

The engagement of the opposing end portion of the valance 56 with the pocket 26d′ of the endcap 20 is similar to the engagement between the valance 22 and the pocket 26d′ described above in connection with the embodiment of FIGS. 1-6 and therefore will not be described in detail. The decorative profile of the 32b′ of the endcap 20 appears to be continuous with the decorative profile of the outer surface 56a of the valance 56.

Due to the connection of the endcaps 18 and 20 to the wall 14, the extension of the valance 54 between the endcap 18 and the joint element 52, and the extension of the valance 56 between the joint element 52 and the endcap 20, a volume 62 (FIG. 7) is defined by the wall 14 and the inner surfaces 24c, 24c′, 26c, 26c′, the inner surfaces of the valances 54 and 56, and the inner surface of the joint element 52.

In operation, the tops of the drapes 16a and 16b, the rod 15, and any other associated hardware used to support and/or suspend the drapes 16a and 16b, are disposed in the volume 62 and concealed from view by the endcaps 18 and 20, the valances 54 and 56, and the joint element 52. The decorative profiles 32a, 32b, 32a′, 32b′, 52e, and the profiles of the outer surface 54a and 56a aesthetically enhance the window 12, the wall 14, the drapes 16a and 16b and/or the surrounding environment.

To assemble the cornice box 50, it is understood that the lengths of the valances 54 and 56 may be reduced if the combined length of the valances is appreciably greater than the width of the window 12. The aforementioned measurement markings on the inner surfaces of the valances 54 and 56 indicate the lengths of the valances. To reduce the length of either the valance 54 or 56, the valance may be cut at any location therealong, with the cutting plane substantially perpendicular to the extension of the measurement markings which, in turn, may be used to indicate the amount of material being cut and/or the length of the remaining uncut portion of the valance.

An end portion of the valance 54 is inserted and slid into the corresponding pocket 26d and the fasteners 29a and 29b are driven through the inner surface 26c and into the end portion of the valance, thereby removably securing the valance to the endcap 18. Likewise, the opposing end portion of the valance 54 is inserted and slid into the corresponding pocket 52f and the fasteners 58a and 58b are driven through the inner surface of the joint element 52 and into the end portion of the valance, thereby removably securing the valance to the joint element. It is understood that the opposing end portions of the valance 54 may be inserted into the pockets 26d and 52f before driving any of the fasteners 29a, 29b, 58a or 58b into the valance or, as discussed above, use of the fasteners 29a, 29b, 58a or 58b may be omitted.

An end portion of the valance 56 is inserted and slid into the corresponding pocket 52g and the fasteners 60a and 60b are driven through the inner surface of the joint element 52 and into the end portion of the valance, thereby removably securing the valance to the joint element. Likewise, the opposing end portion of the valance 56 is inserted and slid into the corresponding pocket 26d′ and the fasteners 29a and 29b are driven through the inner surface 26c′ and into the end portion of the valance, thereby removably securing the valance to the endcap 20. It is understood that the opposing end portions of the valance 56 may be inserted into the pockets 52g and 26d′ before driving any of the fasteners 60a, 60b, 29a or 29b into the valance or, as discussed above, use of the fasteners 29a, 29b, 60a or 60b may be omitted.

The installation of the cornice box 50 is substantially similar to the installation of the cornice box 10 of the embodiment of FIGS. 1-6 discussed above and therefore will not be described in detail. In addition to the installation procedure discussed above in connection with the cornice box 10, it is understood that the cornice box 50 may be installed in any conventional manner.

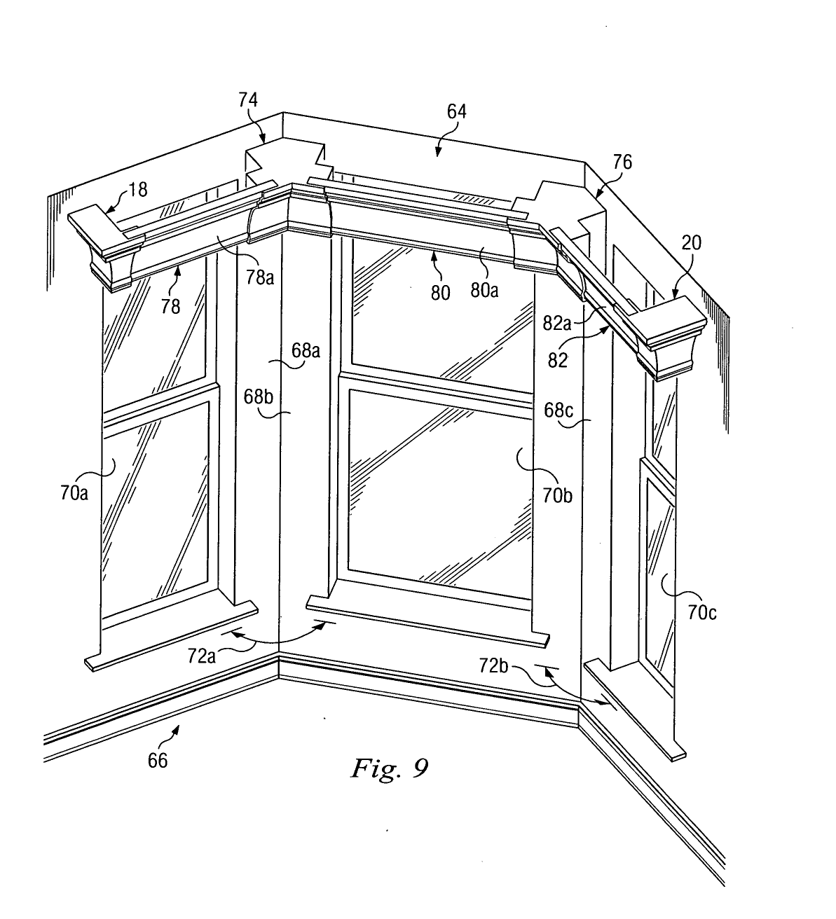

Referring to FIG. 9, another embodiment of a furnishing accessory, in the form of a cornice box, is generally referred to by the reference numeral 64. The embodiment shown in FIG. 9 is similar to the embodiment shown in FIGS. 1-6 and contains several parts of the embodiment which are given the same reference numerals. In the embodiment of FIG. 9, the cornice box 64 is positioned over a bay window arrangement 66, which includes walls 68a, 68b and 68c, and windows 70a, 70b and 70c formed therein, respectively. Angles 72a and 72b are defined between the walls 68a and 68b, and the walls 68b and 68c, respectively.

The endcaps 18 and 20 are connected to the wall 68a and 68c, respectively. A joint element 74 is connected to the walls 68a and 68b, and a joint element 76 is connected to the walls 68b and 68c. A design element, in the form of a protrusion or valance 78 defining an outer surface 78a, extends between and is engaged with the endcap 18 and the joint element 74. A design element, in the form of a protrusion or valance 80 defining an outer surface 80a, extends between and is engaged with the joint elements 74 and 76. A design element, in the form of a protrusion or valance 82 defining an outer surface 82a, extends between and is engaged with the joint element 76 and the endcap 20.

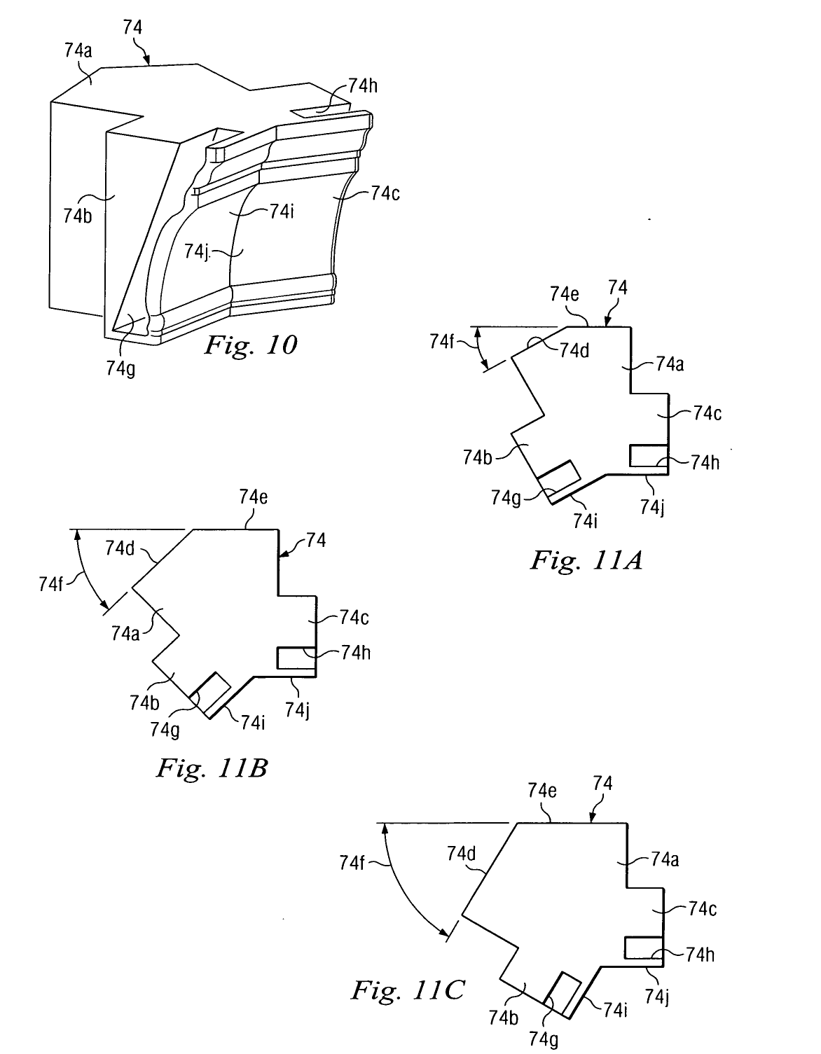

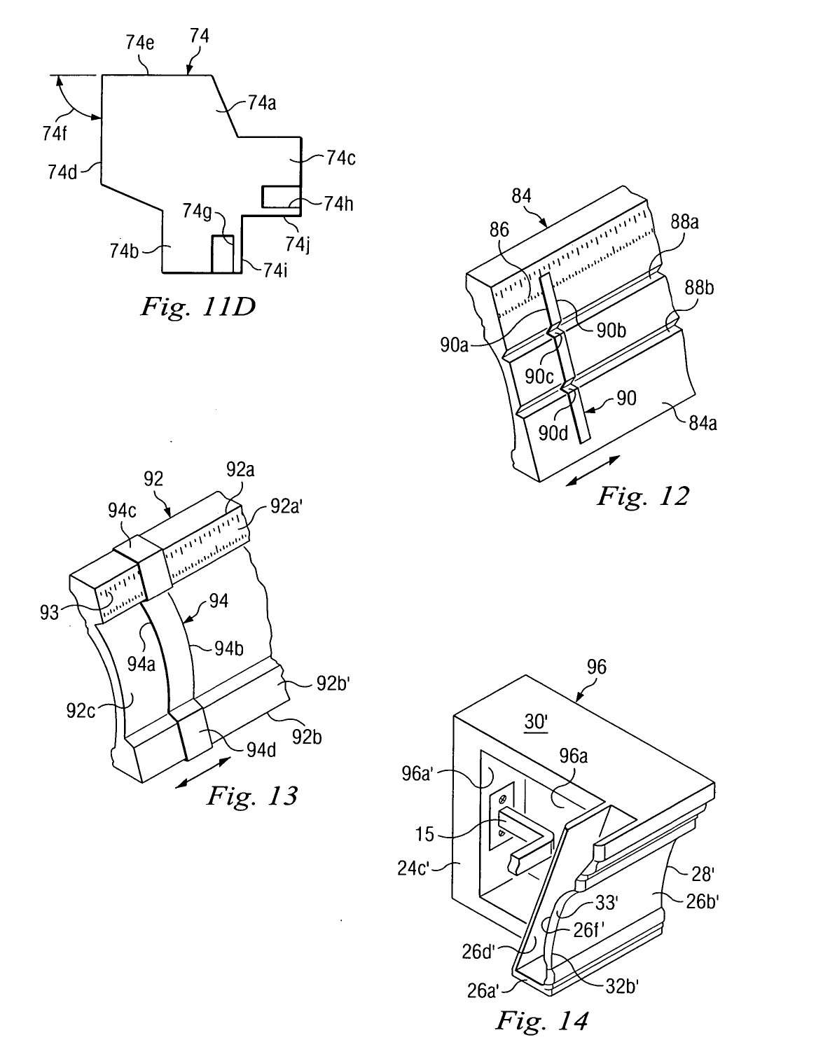

Referring to FIGS. 10 and 11A, the joint element 74 includes protrusions 74a, 74b and 74c. The protrusion 74a defines surfaces 74d and 74e, the top edges of which are shown in FIG. 11A, and which, in turn, define an angle 74f. The angle 74f is supplementary to the angle 72a, and enables surfaces 74d and 74e to contact the walls 68a and 68b, respectively. For example, as shown in FIG. 11A, the angle 74f may be 30 degrees. In this case, the angle 72a would be 150 degrees.

Pockets 74g and 74h are formed in the protrusions 74b and 74c, respectively, and receive the valances 78 and 80, respectively, so that the valances are slidably engaged with the pockets. The protrusions 74b and 74c define surfaces 74i and 74j. The decorative profiles of the surfaces 74i and 74j appear to be continuous with the decorative profiles of the outer surfaces 78a and 80a, respectively. Moreover, the rounds adjacent the pockets 74g and 74h further promote the appearance of continuity between the joint element 74 and the valances 78 and 80.

The joint element 76 is substantially the same as the joint element 74 and therefore will not be described in detail. The sliding engagements between the joint element 76 and the valances 80 and 82 are substantially the same as the sliding engagements between the joint element 74 and the valances 78 and 80, and therefore will not be described in detail.

It is understood that the functional and aesthetic aspects of the engagements between the valance 78 and the endcap 18, the valance 78 and the joint element 74, the valance 80 and the joint elements 74 and 76, the valance 82 and the joint element 76, and the valance 82 and the endcap 20 are similar to the aspects described above in connection with the engagements involving the valance 22 of the embodiment of FIGS. 1-6 and the valances 54 and 56 of the embodiment of FIGS. 7-8, and therefore will not be described in detail.

It is understood that fasteners may be used to further secure the valance 78 with the endcap 18 and the joint element 74, the valance 80 with the joint elements 74 and 76, and the valance 82 with the joint element 76 and the endcap 80. It is further understood that the use of fasteners in this manner is optional, and that the aforementioned engagements between the valances and the corresponding joint elements are not substantially compromised by the lack of fasteners, for reasons similar to those described above in connection with the embodiments of FIGS. 1-6 and FIGS. 7-8.

It is understood that the assembly and installation of the cornice box 64 may be carried out in a manner similar to that described above in connection with the embodiment of FIGS. 1-6. The lengths of the valances 78, 80 and 82 may be reduced by cutting off portions of the valances. Measurement markings may be formed or printed on the inner surfaces of the valance 78, 80 and 82 (not shown) to facilitate any desired and/or necessary length reductions. It is further understood that two or more valances may extend between the endcap 18 and the joint element 74, between the joint element 74 and the joint element 76, and/or between the joint element 76 and the endcap 20, with a joint element similar to the joint element 52 of the embodiment of FIGS. 7-8 disposed between and connecting the two valances. Moreover, it is further understood that the cornice box 64 may be installed in a conventional manner.

It is understood that the angle 74f may be varied to accommodate a wide variety of bay window arrangements including, but not limited to, bay window arrangements having different angles 72a, as shown in FIGS. 11A through 11D. For example, FIG. 11B depicts the angle 74f as a 45-degree angle, in which case the angle. 72a would be 135 degrees. FIG. 11C depicts the angle 74f as a 60-degree angle, in which case the angle 72a would be 120 degrees. FIG. 11D depicts the angle 74f as a 90-degree angle, in which case the angle 72a would be 90 degrees. It is further understood that the joint elements 74 and/or 76 may be used to accommodate right angles in rooms and other spaces so that resulting furnishing accessories, such as cornice boxes, may extend across one or more walls.

Referring to FIG. 12, another embodiment of a design element, in the form of a protrusion or valance, is generally referred to by the reference numeral 84, and includes an inner surface 84a. A plurality of measurement markings 86 are printed or formed on the inner surface 84a, and extend along the length of the valance 84. A pair of V-shaped grooves 88a and 88b are formed in the inner surface 84a, and extend along the length of the valance 84 in a spaced, parallel relation to each other and to the measurement markings 86.

A bracket 90, having straight edges 90a and 90b and a pair of V-shaped projections 90c and 90d, is removably engaged with the valance 84. The V-shaped projections 90c and 90d extend into the V-shaped grooves 88a and 88b, respectively.

In operation, the bracket 90 is engaged with the valance 84 as shown in FIG. 12. The bracket 90 may then be slid along the length of the valance 84, in either direction as indicated by the arrow in FIG. 12. The extensions of the V-shaped projections 90c and 90d into the V-shaped grooves 88a and 88b, respectively, control the movement of the bracket 90, substantially restricting the direction of relative movement between the bracket and the valance 84 to the directions indicated by the arrows in FIG. 12. The bracket 90 is slid to a desired location corresponding to a desired measurement marking in the plurality of measurement markings 86. The desired measurement marking corresponds to the desired length of the valance 84. A marking or line is drawn or formed on the inner surface 84a of the valance 84, with the line corresponding to one of the straight edges 90a or 90b of the bracket 90, thereby providing a straight line on the inner surface 84a that corresponds to the desired measurement. The valance 84 is then cut along the straight line, resulting in a substantially straight cut and the valance having the desired length. The bracket 90 is then removable from the valance 84.

The valance 84 may be used to assemble and install a furnishing accessory according to any of the above or below-described furnishing-accessory embodiments.

It is understood that the valance 84 may have additional features that are similar to any of the design element embodiments discussed in connection with the furnishing accessory embodiments of FIGS. 1-6, FIGS. 7-8 and/or FIGS. 9-11D. It is further understood that the valance 84 may be used in place of any of the design element embodiments discussed in connection with the furnishing accessory embodiments of FIGS. 1-6, FIGS. 7-8 and/or FIGS. 9-11D. It is further understood that the shapes of the grooves 88a and 88b may be varied, and that the shapes of the projections 90c and 90d may also be varied accordingly.

Referring to FIG. 13, another embodiment of a design element, in the form of a protrusion or valance, is generally referred to by the reference numeral 92, and includes protrusions 92a and 92b which define substantially flat surfaces 92a′ and 92b′, respectively. A curved surface 92c extends between the protrusions 92a and 92b. A plurality of measurement markings 93 are printed or formed on the surface 92a′, and extend along the length of the valance 92.

A bracket 94 having a pair of edges 94a and 94b is engaged with the valance 92. The general shape of the bracket 94 corresponds to the continuous contour defined by the protrusions 92a and 92b and the curved surface 92c. Symmetric end portions 94c and 92d of the bracket 94 extend over the protrusions 92a and 92b. The distance between corresponding locations of the end portions 94c and 94d is such that the bracket clamps over the valance 92. However, the degree of clamping is also such that the bracket 94 is able to slide along the length of the valance 92.

In operation, the bracket 94 is engaged with the valance 92 as shown in FIG. 13. The bracket 94 may then be slid along the length of the valance 92, in either direction as indicated by the arrows in FIG. 13. The extensions of the end portions 94c and 94d, and the associated clamping of the bracket 94 over the valance 92, control the movement of the bracket, substantially restricting the direction of relative movement between the bracket and the valance to the directions indicated by the arrows in FIG. 13. The bracket 94 is slid to a desired location corresponding to a desired measurement marking in the plurality of measurement markings 93. The desired measurement marking corresponds to the desired length of the valance 92. A marking or line is drawn or formed on one or more of the surfaces of the valance 92, such as the surfaces 92a′, 92c and/or 92b′, with the line corresponding to one of the edges 94a or 94b of the bracket 94, thereby providing a line that corresponds to the desired measurement. The valance 92 is then cut along the line, resulting in a substantially straight cut and the valance having the desired length.

It is understood that the shape of the valance 92 may be varied, including the removal or modification of the protrusions 92a and 92b, and of the curved surface 92c, and the inclusion of additional features. It is further understood that the shape of the bracket 94 may also be modified accordingly. It is understood that the shapes of the valance 92 and the bracket 94 may be dictated by production considerations, including manufacturing methods such as, for example, the molding of the valance 92.

It is understood that the valance 92 may have additional features that are similar to any of the design element embodiments discussed in connection with the furnishing accessory embodiments of FIGS. 1-6, FIGS. 7-8 and/or FIGS. 9-11D. It is further understood that the valance 92 may be used in place of any of the design element embodiments discussed in connection with the furnishing accessory embodiments of FIGS. 1-6, FIGS. 7-8 and/or FIGS. 9-11D.

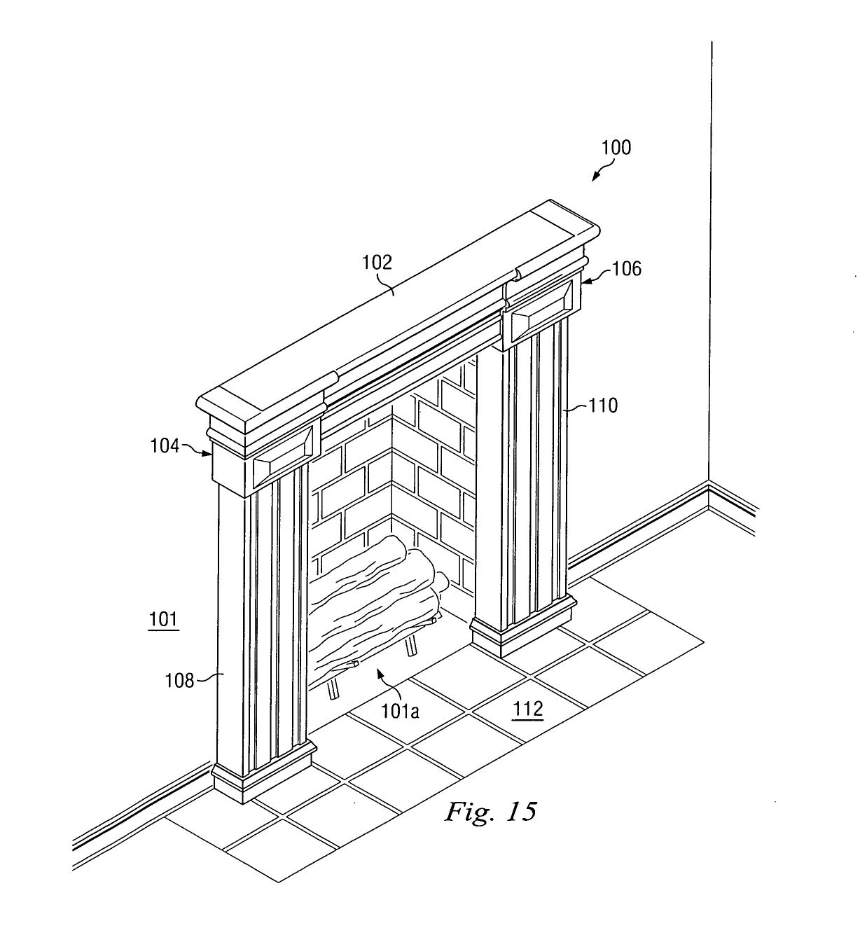

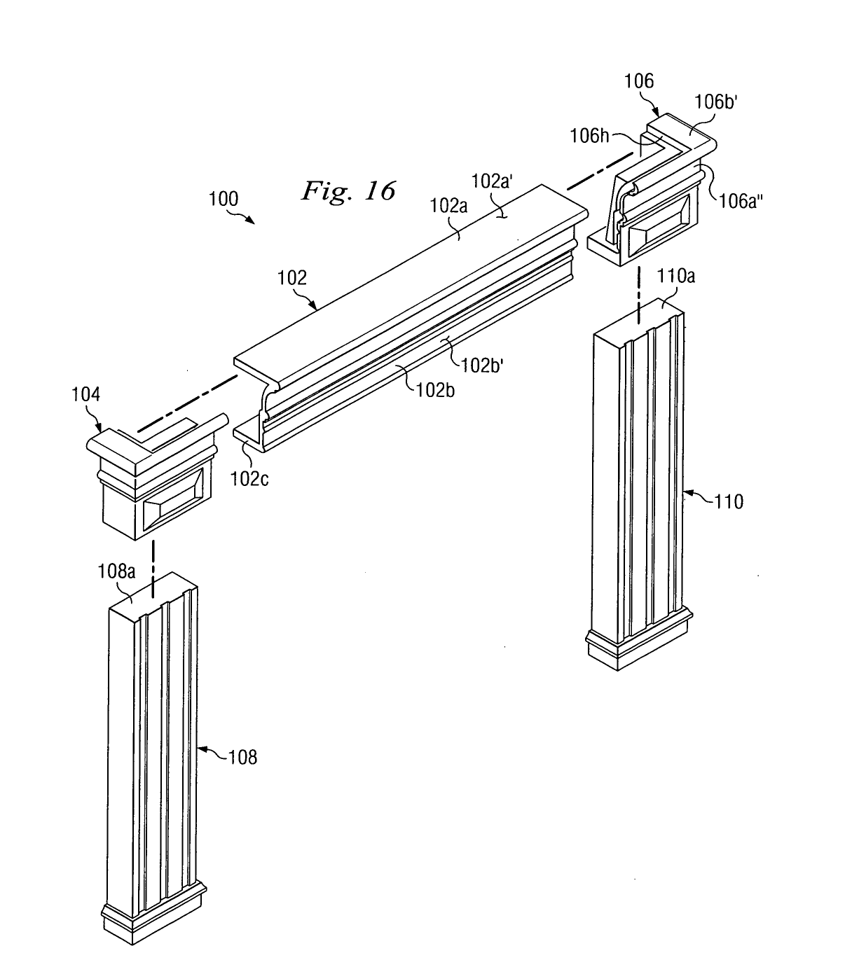

Referring to FIG. 14, another embodiment of a joint element or endcap is generally referred to by the reference numeral 96. The endcap 96 is similar to the endcap 20 shown in FIGS. 1-6 and contains several parts of the embodiment which are given the same reference numerals. A cavity 96a is formed in the inner surface 24c′ and defines a surface 96a′. The rod 15 is engaged with the surface 96a′ of the cavity 96a.

In operation, when used in conjunction with another endcap that is symmetrically equivalent to the endcap 96 to form an embodiment of a furnishing accessory similar to that of the embodiment of FIGS. 1-6 or FIGS. 7-8, the need for the rod 15 to be connected to the wall 14 is eliminated. In a like manner, the need for any rods to be connected to the walls 68a, 68b and 68c is eliminated when an embodiment of a furnishing accessory similar to that of the embodiment of FIGS. 9-11D is formed by using the endcap 96 in conjunction with an endcap symmetrically equivalent thereto, and by forming cavities similar to the cavity 96 on either side of each of the protrusions 74a and 76a of the joint elements 74 and 76, respectively.

The remaining aspects of the operation of the endcap 96 are similar to that of the endcap 20 and therefore will not be described. It is understood that the installation of any furnishing accessory embodiment incorporating the endcap 96 may be carried out in a manner similar to the installation procedure described above in connection with the furnishing accessory embodiment of FIGS. 1-6, or may be carried out in any conventional manner.

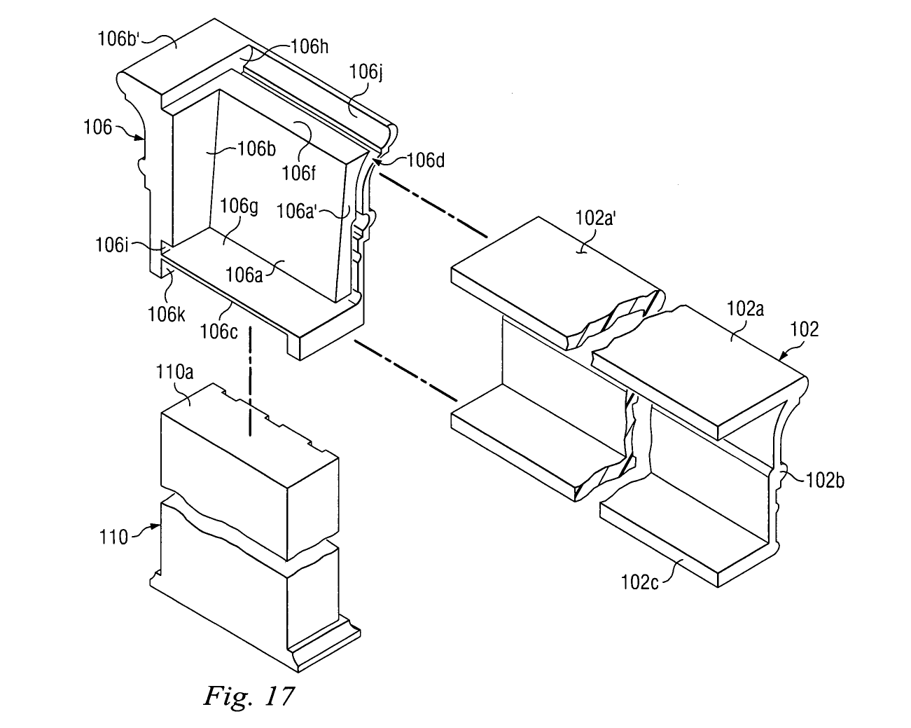

Referring to FIGS. 15-17, another embodiment of a furnishing accessory, in the form of a mantel, is generally referred to by the reference numeral 100 and is positioned against a wall 101 so that the mantel surrounds or frames a fireplace 101a formed in the wall. A design element, in the form of a shelf 102, extends between and is slidably engaged with joint elements or endcaps 104 and 106. The cross-section of the shelf 102 is generally in the form of a backwards “C” and includes a protrusion 102a defining a top surface 102a′, a protrusion 102b defining an outer surface 102b′ having a decorative profile, and a protrusion 102c. Design elements, in the form of protrusions or columns 108 and 110 having end surfaces 108a and 110a, respectively, extend upwards from a horizontal surface 112 and are slidably engaged with the endcaps 104 and 106, respectively, so that the columns are in a spaced, parallel relation.

The endcap 106 includes protrusions 106a, 106b and 106c. The protrusion 106a defines an end surface 106a′ and an outer surface 106a″ (FIG. 16) defining a decorative profile, and the protrusion 106b defines a top surface 106b′. A pocket 106d extends from the end surface 106a′ of the protrusion 106a and into the protrusions 106a and 106b. The pocket 106d is generally in the form of a backwards “C” and defines horizontal surfaces 106f and 106g, vertical surfaces 106h and 106i and a curved surface 106j. Portions of the profile of the curved surface 106j correspond to portions of the decorative profile of the outer surface 102b′ of the shelf 102. Moreover, the cross-section of the pocket 106d corresponds with the cross-section of the protrusion 102b of the shelf 102, with respect to the pocket's extension from the surface 106a′ and towards the protrusion 106b. A pocket 106k is formed in the protrusion 106c.

The endcap 104 is the symmetric equivalent of the endcap 106 and therefore will not be described in detail.

When the mantel 100 is in its installed condition, as shown in FIG. 15, the end portion of the shelf 102 extends into the pocket 106d so that portions of the profile of the outer surface 106a″ appears to be continuous with portions of the profile of the outer surface 102b′. The correspondence between portions of the profile of the curved surface 106j and the outer surface 102b′ further promotes the appearance of continuity and serves to further suggest that the endcap 106 and the shelf 102 are integrally formed.

Due to the corresponding backward “C” shapes of the cross sections of the shelf 102 and the pocket 106d, the protrusions 102a and 102c of the shelf 102 may be supported by the horizontal surfaces 106f and/or 106g, respectively, of the endcap 106, and the end of the shelf may abut the vertical surfaces 106h and/or 106i. The top surface 102a′ of the shelf 102 and the top surface 106b′ of the endcap 106 appear to form a continuous horizontal surface, further promoting the appearance of continuity between the endcap 106 and the shelf 102. The end portion of the column 110 extends into and slidably engages the pocket 106k of the endcap 106 so that the endcap contacts the surface 110a and the column supports the endcap.

The engagement of the shelf 102 with the endcap 104 is similar to the above-described engagement of the shelf with the endcap 106 and therefore will not be described in detail. The engagement of the column 108 with the endcap 104 is similar to the engagement of the column 110 with the endcap 106 and therefore will not be described in detail.

It is understood that one or more of the protrusions 106a, 106b and 106c prevent the shelf 102 from moving in a vertical direction relative to the endcaps 104 and 106, and vice versa, because of the above-described correspondence between the cross-sections of the shelf and the pocket 106d. It is understood that the degree of movement of the shelf 102 in any direction is dependent upon the presence of gaps between the shelf and the endcaps 104 and 106.

In operation, the mantel 100 frames or surrounds the fireplace 101a and items, decorative or otherwise, may be placed on and/or supported by the continuous horizontal surface formed by the top surface 102a′ of the shelf 102, the top surface 106b′ of the endcap 106 and the corresponding top surface of the endcap 104.

To assemble the mantel 100, it is understood that the length of the shelf 102 may be reduced as desired such as, for example, in cases where the length of the shelf 102 is appreciably greater than the width of the fireplace 101a. It is understood that a plurality of measurement markings, similar to the measurement markings of any of the embodiments described above, may be printed or formed on one or more of the protrusions 102a, 102b and 102c of the shelf 102. Also, it is understood that the heights of the columns 108 and 110 may be reduced as desired by, for example, cutting off portions from the tops of the columns, in order to adjust the distance between the shelf 102 and the horizontal surface 112, that is, in order to adjust the overall height of the mantel 100. It is further understood that a plurality of measurement markings, similar to the measurement markings of any of the embodiments described above, may be printed or formed on the columns 108 and/or 110.

An end portion of the shelf 102 is inserted into the pocket 106d of the endcap 106 and the opposing end portion of the shelf is inserted into the corresponding pocket of the endcap 104. The columns 108 and 110 may be positioned as desired and the endcaps 104 and 106 may be placed over the columns 108 and 110, respectively, so that the column 110 extends into the pocket 106k of the endcap 106 and the column 108 extends into the corresponding pocket of the endcap 104. It is understood that, if the tops of the columns 108 and 110 have been cut off, the extension of the column 110 into the pocket 106k of the endcap 106, and of the column 108 into the corresponding pocket in the endcap 104, conceals from view any physical indications that the tops of the columns have been cut, thereby preserving the overall aesthetics of the mantel 100.

It is understood that two or more shelves may extend between the endcaps 104 and 106 to increase the width of the mantel 100, with a joint element similar to the joint element 52 of the embodiment of FIGS. 7-8 disposed between and connecting the two shelves. In such an extended-width embodiment, it is understood that the joint element would have pockets having cross-sections corresponding to the cross-sections of the shelves.

It is understood that fasteners and/or adhesives may be used to further secure the shelf 102 to the endcaps 104 and/or 106, and to further secure the columns 108 and 110 to the endcaps 104 and 106, respectively.

To install the mantel 100, it is understood that the endcaps 104 and 106 and the columns 108 and 110 may be positioned so that the endcaps and columns are adjacent to, offset from and/or connected to the wall 101 in any conventional manner. Moreover, it is understood that keyhole slots may be formed in or connected to one or more of the endcaps 104 and 106 and the columns 108 and 110 so that the mantel 100 may be installed against the wall 101 in a manner similar to that of the cornice box 10 of the embodiment of FIGS. 1-6. In addition to the installation procedure discussed above in connection with the cornice box 10 of the embodiment of FIGS. 1-6, it is understood that the mantel 100 may be installed in any conventional manner. It is understood that the mantel 100 may be freestanding.

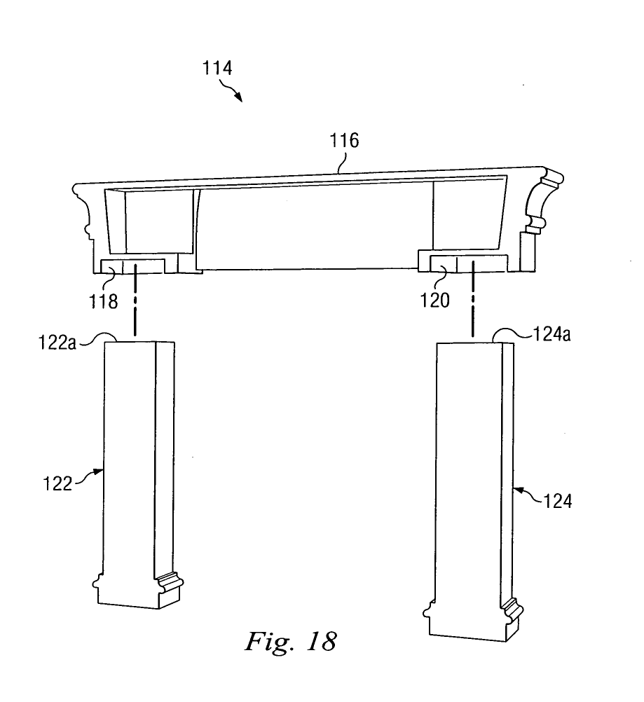

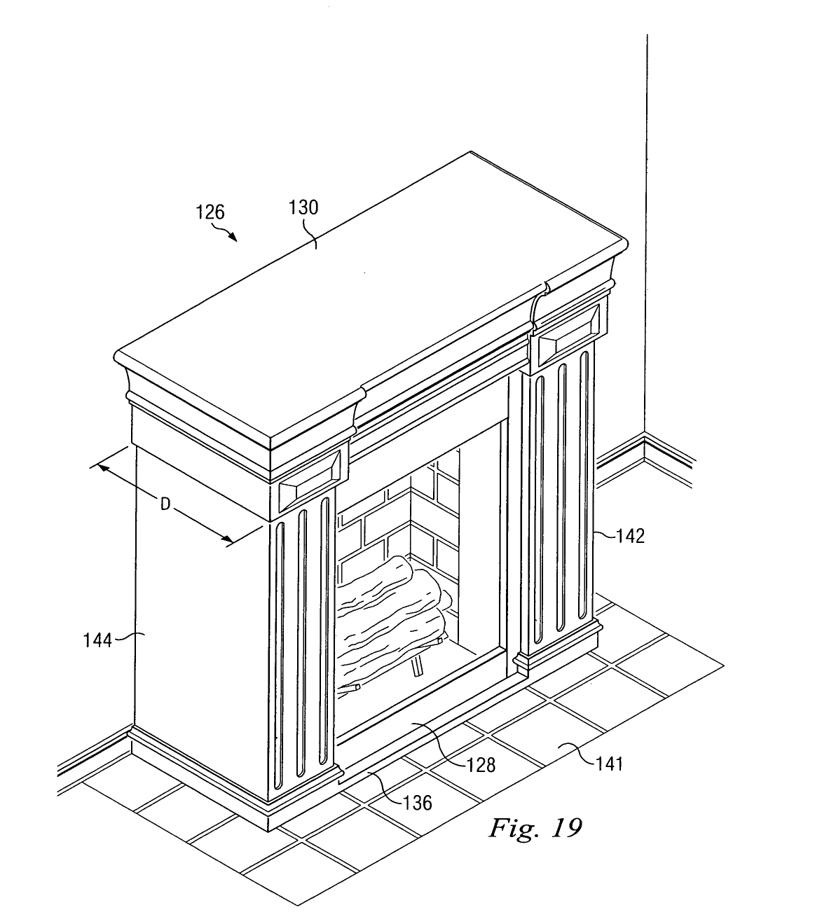

Referring to FIG. 18, another embodiment of a furnishing accessory, in the form of a mantel, is generally referred to by the reference numeral 114. A design element, in the form of a shelf 116, includes a pair of pockets 118 and 120. It is understood that the remainder of the shelf 116 substantially resembles the shelf 102 and the endcaps 104 and 106 of the mantel 100 of the embodiment of FIGS. 15-17 when the shelf 102 and the endcaps 104 and 106 are placed in an assembled condition. However, it is understood that the shelf 116 is a single, integrally-formed part, rather than a plurality of engaged parts.

Design elements, in the form of protrusions or columns 122 and 124 having end surfaces 122a and 124a, respectively, extend upwards from a horizontal surface (not shown) and are slidably engaged with the pockets 118 and 120, respectively, so that the shelf 116 contacts the end surfaces and the columns support the shelf. Although not shown in FIG. 18, it is understood that the shelf 116 and/or the columns 122 and/or 124 may include surfaces defining one or more decorative profiles that may, for example, substantially resemble one or more decorative profiles defined by one or more surfaces of the mantel 100 of the embodiment of FIGS. 15-17.

In operation, the mantel 114 of the embodiment of FIG. 18 frames or surrounds a fireplace and items, decorative or otherwise, may be placed on and/or supported by the shelf 116. During the assembly of the mantel 114 in accordance with the foregoing description, it is understood that the heights of the columns 122 and 124 may be reduced as desired by, for example, cutting off portions from the tops of the columns, in order to adjust the distance between the shelf 116 and the horizontal surface from which the columns extend, that is, in order to adjust the overall height of the mantel 114. If the heights of the columns 122 and 124 are adjusted in this manner, it is understood that the extension of the columns 122 and 124 into the pockets 118 and 120, respectively, conceals from view any physical indications that the tops of the columns have been cut, thereby preserving the overall aesthetics of the mantel 114.

It is further understood that a plurality of measurement markings, similar to the measurement markings of any of the embodiments described above, may be printed or formed on the columns 122 and/or 124. Also, it is understood that fasteners and/or adhesives may be used to further secure the columns 122 and/or 124 to the shelf 116.

To install the mantel 114, it is understood that the shelf 116 and the columns 122 and 124 may be positioned so that the shelf and columns are adjacent to, offset from and/or connected to a wall in any conventional manner. Moreover, it is understood that keyhole slots may be formed in or connected to the shelf 116 and the columns 122 and 124 so that the mantel 114 may be installed against a wall in a manner similar to that of the cornice box 10 of the embodiment of FIGS. 1-6. In addition to the installation procedure discussed above in connection with the cornice box 10 of the embodiment of FIGS. 1-6, it is understood that the mantel 114 may be installed in any conventional manner. It is understood that the mantel 114 may be freestanding.

It is understood that the shelf 116 may be modified so that the shelf 116 is similar to the arrangement of the endcaps 104 and 106 and the shelf 102 of the mantel 100 of the embodiment of FIGS. 15-17, with the shelf 116 being composed of a pair of spaced joint elements or endcaps between which a design element, in the form of a shelf, extends and with which the design element is slidably engaged.

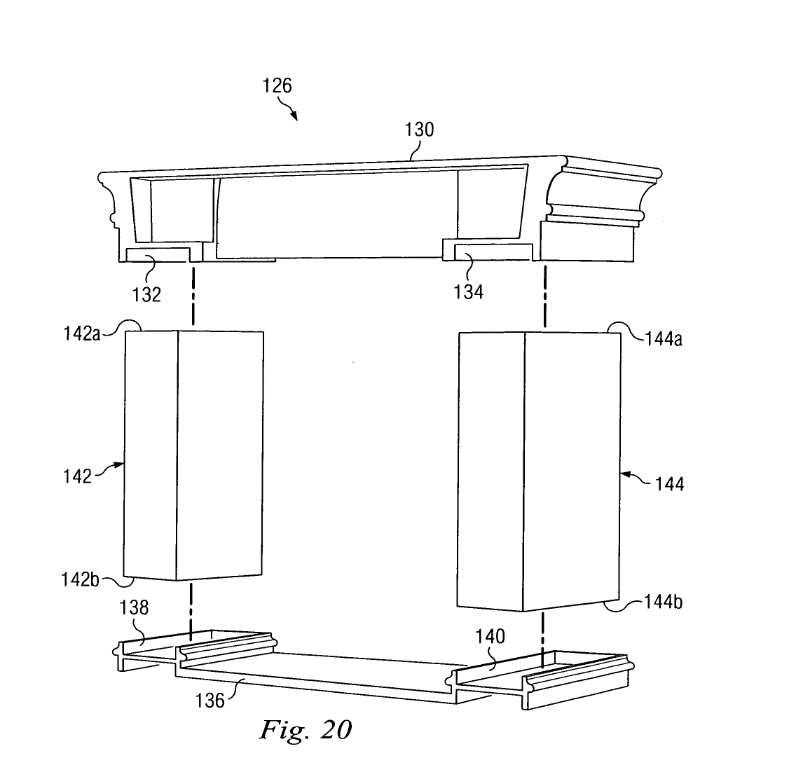

Referring to FIGS. 19-20, another embodiment of a furnishing accessory, in the form of a mantel, is generally referred to by the reference numeral 126 and is sized and positioned to surround or frame an electric fireplace unit 128. A design element, in the form of a shelf 130, includes a pair of pockets 132 and 134 and defines a depth dimension D. It is understood that the remainder of the shelf 130 substantially resembles the shelf 116 of the embodiment of FIG. 18, except that the depth dimension D of the shelf 130 is larger in size than the corresponding depth dimension of the shelf 116 in order for the mantel 126 to surround or frame the electric fireplace unit 128. As shown in FIG. 19, it is further understood that shelf 130 may include surfaces defining one or more decorative profiles that may, for example, substantially resemble one or more decorative profiles defined by one or more surfaces of the mantel 100 of the embodiment of FIGS. 15-17 and/or the mantel 114 of the embodiment of FIG. 18. It is further understood that the shelf 130 is a single, integrally-formed part, rather than a plurality of engaged parts.

A design element, in the form of a horizontally-extending base 136, includes a pair of pockets 138 and 140 and rests on a horizontal surface 141. Design elements, in the form of protrusions or columns 142 and 144 having end surfaces 142a and 144a, respectively, and end surfaces 142b and 144b, respectively, extend between the shelf 130 and the base 136. The columns 142 and 144 are slidably engaged with the pockets 132 and 134, respectively, so that the shelf 130 contacts the end surfaces 142a and 144a and the columns support the shelf. Moreover, the columns 142 and 144 are slidably engaged with the pockets 138 and 140, respectively, so that the end surfaces contact the base 136 and the base supports the columns.

In operation, as noted above, the mantel 126 frames or surrounds the electric fireplace unit 128 and items, decorative or otherwise, may be placed on and/or supported by the shelf 130. During the assembly of the mantel 126 in accordance with the foregoing description, it is understood that the heights of the columns 142 and 144 may be reduced as desired by, for example, cutting off portions from the tops of the columns, in order to adjust the distance between the shelf 130 and the horizontal surface 141, that is, in order to adjust the overall height of the mantel. If the heights of the columns 142 and 144 are adjusted in this manner, it is understood that the extension of the columns 142 and 144 into the pockets 132 and 134, respectively, conceals from view any physical indications that the tops of the columns have been cut, thereby preserving the overall aesthetics of the mantel 126.

In a similar manner, the heights of the columns 142 and 144 may be reduced by cutting off portions from the bottoms of the columns. If the heights of the columns 142 and 144 are adjusted in this manner, it is understood that the extension of the columns 142 and 144 into the pockets 138 and 140, respectively, conceals from view any physical indications that the bottoms of the columns have been cut, thereby preserving the overall aesthetics of the mantel 126.

It is further understood that a plurality of measurement markings, similar to the measurement markings of any of the embodiments described above, may be printed or formed on the columns 142 and/or 144. Also, it is understood that fasteners and/or adhesives may be used to further secure the columns 142 and/or 144 to the shelf 130 and/or the base 136.

It is understood that the installation of the mantel 126 may be similar to the installation of the mantel 114 of the embodiment of FIG. 18 and therefore the installation of the mantel 114 will not be described in detail. It is understood that the mantel 126 may be freestanding.

It is understood that the shelf 130 may be modified so that the shelf 130 is similar to the arrangement of the endcaps 104 and 106 and the shelf 102 of the mantel 100 of the embodiment of FIGS. 15-17, with the shelf 130 being composed of a pair of spaced joint elements or endcaps between which a design element, in the form of a shelf, extends and with which the design element is slidably engaged.

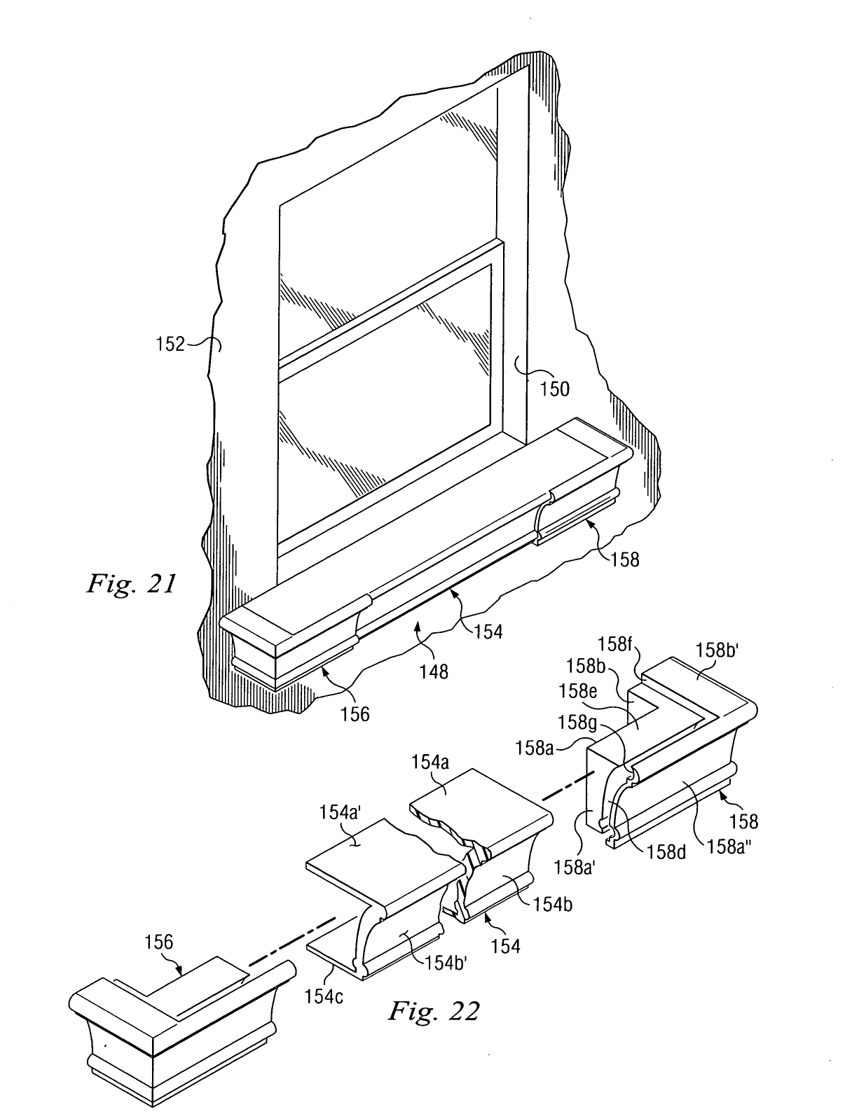

Referring to FIGS. 21-22, another embodiment of a furnishing accessory, in the form of a shelving unit or window sill, is generally referred to by the reference numeral 148. A window 150 is formed in a wall 152, and the window sill 148 is positioned adjacent the window. A design element, in the form of a shelf 154, extends between and is slidably engaged with joint elements or endcaps 156 and 158. The cross-section of the shelf is generally in the form of a backwards “C” and includes a protrusion 154a defining a top surface 154a′, a protrusion 154b defining an outer surface 154b′ having a decorative profile, and a protrusion 154c.

The endcap 158 includes protrusions 158a and 158b. The protrusion 158a defines an end surface 158a′ and outer surface 158a″ defining a decorative profile, and the protrusion 158b defines a top surface 158b′. A pocket 158d extends from the end surface 158a′ of the protrusion 158a and into the protrusions 158a and 158b. The pocket 158d defines a horizontal surface 158e, a vertical surface 158f, and a curved surface 158g. It is understood that the pocket 158d may define additional surfaces of the protrusions 158a and/or 158b such as, for example, an additional vertical surface of the protrusion 158b near the bottom of the protrusion 158b (not shown). Portions of the profile of the curved surface 158g correspond to portions of the decorative profile of the outer surface 154b′ of the shelf 154. Moreover, the cross-section of the pocket 158d corresponds with the cross-section of the protrusion 154b of the shelf 154, with respect to the pocket's extension from the surface 158a′ and towards the protrusion 158b.

The endcap 156 is the symmetric equivalent to the endcap 158 and therefore will not be described in detail.

When the window sill 148 is in its installed condition, as shown in FIG. 21, an end portion of the shelf 154 extends into the pocket 158d so that portions of the profile of the outer surface 158a″ appears to be continuous with portions of the profile of the outer surface 154b′. The correspondence between the portions of the profiles of the curved surface 158g and the outer surface 154b′ further promotes the appearance of continuity and serves to further suggest that the endcap 158 and the shelf 154 are integrally formed.

The protrusion 154a is supported by the horizontal surface 158e and an end of the shelf 154 may abut the vertical surface 158f. The top surface 154a′ of the shelf 154 and the top surface 158b′ of the endcap 158 appear to form a continuous horizontal surface, as shown in FIG. 21, further promoting the appearance of continuity between the endcap 158 and the shelf 154.

The engagement of the shelf 154 is with the endcap 156 is similar to the above-described engagement of the shelf with the endcap 158 and therefore will not be described in detail.

It is understood that the protrusions 158a and/or 158b prevent the shelf 154 from moving in a vertical direction relative to the endcaps 156 and 158, and vice versa, because of the above-described correspondence between the cross-sections of the protrusion 154b and the pocket 158d. Moreover, the walls of the pocket 158d defined within the protrusion 158a, including the curved surface 158g, prevent the shelf 154 from moving in a direction towards or away from the wall 152, relative to the endcaps 156 and 158, and vice versa. Also, when the window sill 148 is installed as described above, the vertical surface 158f of the endcap 158 and the corresponding vertical surface of the endcap 156 prevent the shelf 154 from moving in a direction parallel to the wall 152. It is understood that the degree of movement of the shelf 154 in any direction is dependent upon the presence of gaps between the shelf and the endcaps 156 and 158. For example, it is understood that the degree of movement of the shelf 154 in a direction parallel to the wall 152 is dependent upon the gaps, if any, between the ends of the shelf and the vertical surface 158f of the endcap 158, and the corresponding symmetric vertical surface of the endcap 156.

In operation, the window sill 148 is adjacent the window 150 and items, decorative or otherwise, may be placed on and/or supported by the continuous horizontal surface formed by the top surface 154a′ of the shelf 154, the top surface 158b′ of the endcap 158 and the corresponding top surface of the endcap 156.

To assemble the window sill 148, it is understood that the length of the shelf 154 may be reduced as desired such as, for example, in cases where the length of the shelf 154 is appreciably greater than the width of the window 150. It is understood that a plurality of measurement markings, similar to the measurement markings of any of the embodiments described above, may be printed or formed on one or more of the protrusions 154a, 154b and 154c of the shelf 154.

An end portion of the shelf 154 is inserted into the pocket 158d of the endcap 158 and the opposing end portion of the shelf is inserted into the corresponding pocket of the endcap 156. It is understood that, if one or more portions of the shelf 154 have been cut off to reduce the length of the shelf, as described above, the extension of the shelf into the pocket 158d of the endcap 158 and the corresponding pocket of the endcap 156 conceals from view any physical indications that the shelf has been cut, thereby preserving the overall aesthetics of the window sill 148.

It is understood that two or more shelves may extend between the endcaps 156 and 158 to increase the width of the window sill 148, with a joint element similar to the joint element 52 of the embodiment of FIGS. 7-8 disposed between and connecting the two shelves. In such an extended-width embodiment, it is understood that the joint element would have pockets having cross-sections corresponding to the cross-sections of the shelves.

It is understood that fasteners and/or adhesives may be used to further secure the shelf 154 to the endcaps 156 and/or 158.

To install the window sill 148, it is understood that the endcaps 156 and 158 may be positioned so that the endcaps are adjacent to, offset from and/or connected to the wall 152 in any conventional manner. Moreover, it is understood that keyhole slots may be formed in or connected to one or more of the endcaps 156 and 158 so that the window sill 148 may be installed against the wall 152 in a manner similar to that of the cornice box 10 of the embodiment of FIGS. 1-6. In addition to the installation procedure discussed above in connection with the cornice box 10 of the embodiment of FIGS. 1-6, it is understood that the window sill 148 may be installed in any conventional manner.

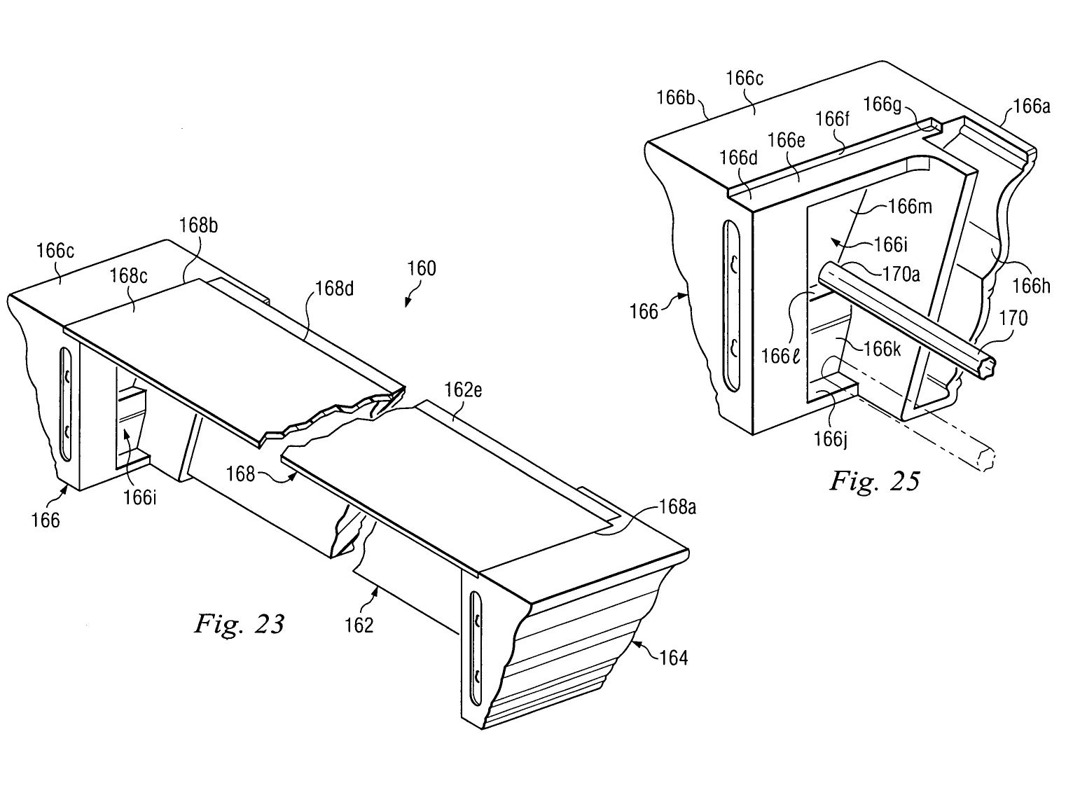

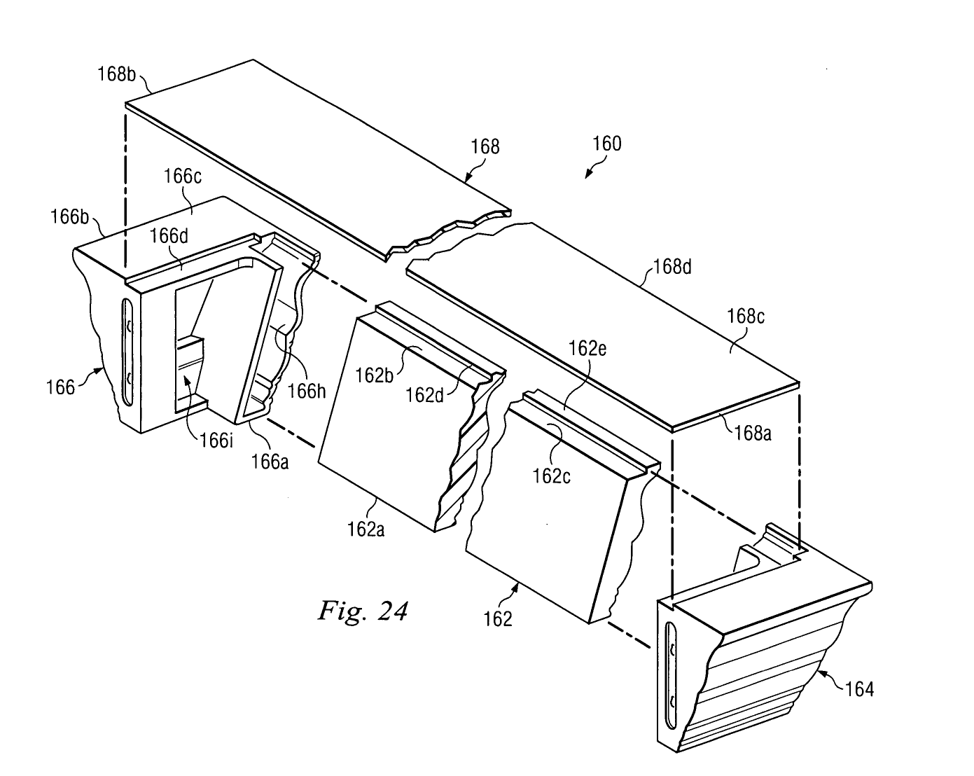

Referring to FIGS. 23-25, another embodiment of a furnishing accessory is generally referred to by the reference numeral 160. A design element 162 extends between and is engaged with joint elements or endcaps 164 and 166, and includes a protrusion 162a. An external recess 162b is formed in and extends along the longitudinal length of the protrusion 162a, thereby defining a horizontal surface 162c and a vertical surface 162d. The design element 162 further defines a top surface 162e.

The endcap 166 includes protrusions 166a and 166b, which together define a top surface 166c. An external recess 166d is formed in the protrusions 166a and 166b, thereby defining a horizontal surface 166e and vertical surfaces 166f and 166g. A pocket 166h is disposed in the protrusion 166b. A cavity 166i is formed in the protrusion 166b, thereby defining surfaces 166j, 166k, 166l and 166m. The remaining features of the endcap 166 are similar to corresponding features of the endcap 20 of the embodiment of FIGS. 1-6, and therefore the endcap 166 will not be described in further detail. The endcap 164 is the symmetric equivalent to the endcap 166 and therefore will not be described in detail.

A panel 168 extends between the endcaps 164 and 166, and is supported by the endcaps and the design element 162. The panel 168 includes ends 168a and 168b, and defines a top surface 168c and a front edge 168d.

When the furnishing accessory is in its installed condition, as shown in FIG. 23, an end portion of the design element 162 is received by the pocket 166h, and the other end portion of the design element is similarly received by the pocket of the endcap 164. The end 168b of the panel 168 is received by the external recess 166d of the endcap 166 so that the panel contacts the surface 166e and is supported by the endcap 166, the end 168b of the panel 168 is proximate or abuts the vertical surface 166f, and the edge 168d of the panel is proximate or abuts the vertical surface 166g. The end 168a of the panel is similarly received by the external recess of the endcap 164 so that the panel is supported by the endcap 164. The surface 166f of the endcap 166, and the corresponding surface of the endcap 164, capture the panel 168 with respect to relative horizontal movement in the direction of extension of the panel and between the panel and one or more other elements of the furnishing accessory 160.

The panel 168 is further received by the external recess 162b of the design element 162 so that the panel contacts the surface 162c and is supported by the design element, and the edge 168d is proximate or abuts the surface 162d. The surface 168c of the panel 168, the surface 166c of the endcap 166 and the corresponding surface of the endcap 164, and the surface 162e of the design element 162 appear to form a continuous horizontal surface, promoting the appearance of continuity between the endcaps 164 and 166, the design element 162 and the panel 168. In several exemplary embodiments, fasteners and/or adhesives may be used to further secure the design element 162 to the endcaps 164 and/or 166, and/or the panel 168 to the endcaps 164 and/or 166, and/or to the design element 162.

To assemble the furnishing accessory 160, the length of the design element 162 and the length of the panel 168 may be reduced as desired by removing one or more portions thereof. In an exemplary embodiment, a plurality of measurement markings, similar to the measurement markings of any of the embodiments described above, may be printed and/or formed on and/or in the design element 162 and/or the panel 168. In an exemplary embodiment, two or more design elements may extend between the endcaps 164 and 166 to increase the width of the furnishing accessory 160, with a joint element, which is similar to the joint element 52 of the embodiment of FIGS. 7-8 but includes an external recess along its length, disposed between and connecting the two design elements.

In an exemplary embodiment, the furnishing accessory 160 may be installed in a manner similar to the installation procedure described above in connection with the cornice box 10 of the embodiment of FIGS. 1-6, in any conventional manner, and/or in any combination thereof.

In operation, the furnishing accessory 160 may be in the form of and/or may function as a cornice box, a window sill, a shelving unit, a mantel and/or any other type of furnishing accessory, and/or any combination thereof. If the furnishing accessory 160 is connected to a vertical surface such as, for example, a wall, so that the panel 168 is proximate or contacting the wall, then the panel 168 is generally captured at least in a horizontal plane, that is, generally prevented from moving in the horizontal plane, either in a direction parallel to the wall, or towards or away from the wall, by the wall, the surfaces 166f and 166g of the endcap 166 and the corresponding surfaces of the endcap 164, and the surface 162d of the design element 162. Moreover, in an exemplary embodiment, the panel 168 may be generally captured in the vertical direction, that is, generally prevented from moving in a downward direction by the surface 166d of the endcap 166 and the corresponding surface of the endcap 164, and the surface 162c of the design element 162, and generally prevented from moving in an upward direction due to the panel 168 being snugly fit between at least the surface 166f of the endcap 166 and the corresponding surface of the endcap 164.

In an exemplary embodiment, as illustrated in FIG. 25, a rod such as, for example, a curtain rod 170, may extend between the endcaps 164 and 166 and be supported by the furnishing accessory 160. More particularly, an end portion 170a of the rod 170 may extend into the cavity 166i of the endcap 166 and engage the surfaces 166m and/or 166l, and the end portion of the rod 170 opposing the end portion 170a may similarly extend into the corresponding cavity of the endcap 164 and engage one or more surfaces of the endcap 164 that correspond to the surfaces 166m and/or 166l.

In an exemplary embodiment, the end portion 170a of the rod 170 may bear against the surface 166m of the endcap 166, and the end portion of the rod opposing the end portion 170a may bear against the surface of the endcap 164 corresponding to the surface 166m of the endcap 166, and, as a result, the rod 170 may be supported by the furnishing accessory 160. It is understood that the rod 170 may bear against the endcaps 164 and 166 in response to the compression of a biasing element disposed in the rod such as, for example, a spring. In an exemplary embodiment, the end portion 170a of the rod 170 may contact the surface 166i, and the end portion of the rod opposing the end portion 170a may contact the surface of the endcap 164 corresponding to the surface 166i of the endcap 166, and, as a result, the rod 170 may be supported by the furnishing accessory.

In an exemplary embodiment, the end portion 170a of the rod 170 may instead extend into the cavity 166i of the endcap 166 and engage the surfaces 166k and/or 166j in a manner similar to that described above in connection with the rod's engagement with the surfaces 166m and/or 166i, respectively.

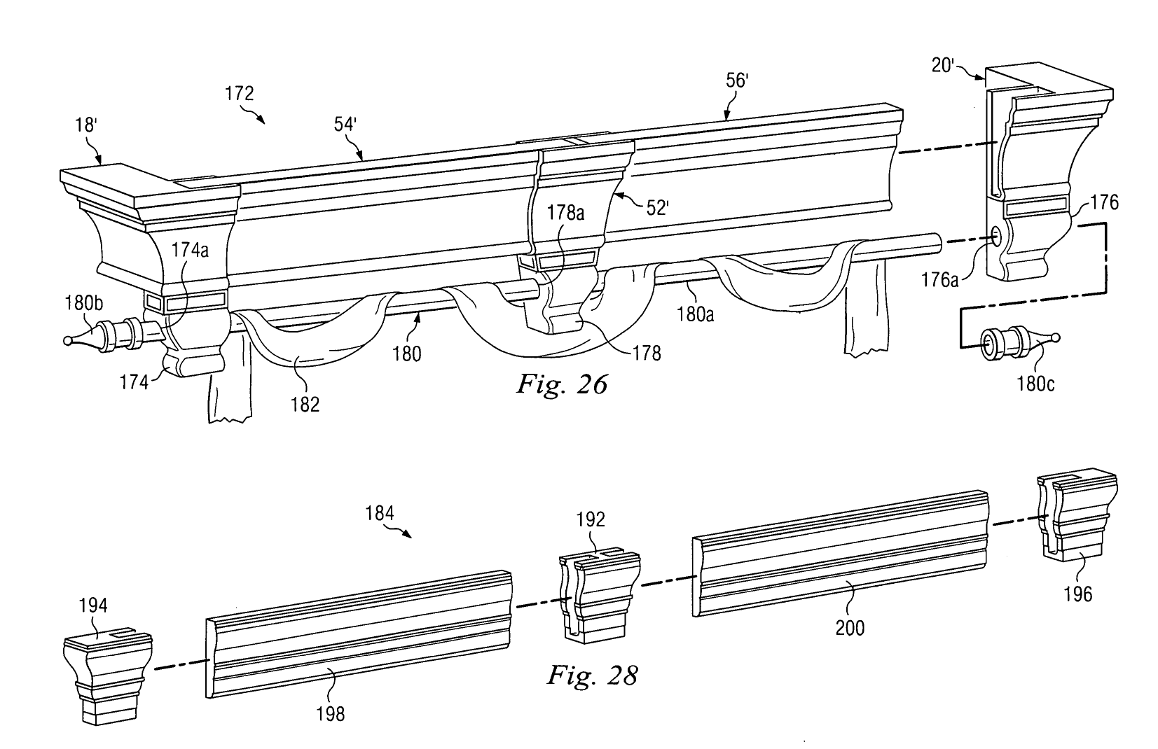

Referring to FIG. 26, another embodiment of a furnishing accessory is generally referred to by the reference numeral 172 and is similar to the embodiment shown in FIGS. 7-8 and contains several parts of the embodiment which are given the same reference numerals, albeit with prime designations. In the embodiment of FIG. 26, the design elements 54′ and 56′ extend in a generally vertical direction, instead of being angularly oriented from their upper surfaces to their inner surfaces.

Moreover, in the embodiment of FIG. 26, substantially symmetric protrusions 174 and 176 extend downwardly from the endcaps 18′ and 20′, respectively. A protrusion 178 extends downwardly from the joint element or keystone 52′. Axially-aligned openings 174a, 176a and 178a are disposed through the protrusions 174, 176 and 178, respectively. A rod 180 includes a middle portion 180a that extends through the openings 174a, 178a and 176a. Finials 180b and 180c are connected to respective opposing ends of the middle portion 180a of the rod 180. A decorative cloth 182 is disposed on the rod 180. In several exemplary embodiments, one or more other articles may be disposed on the rod 180 instead of, or in addition to the cloth 182 such as, for example, curtains, shears, drapes and/or other decorative and/or functional articles, and/or any combination thereof.

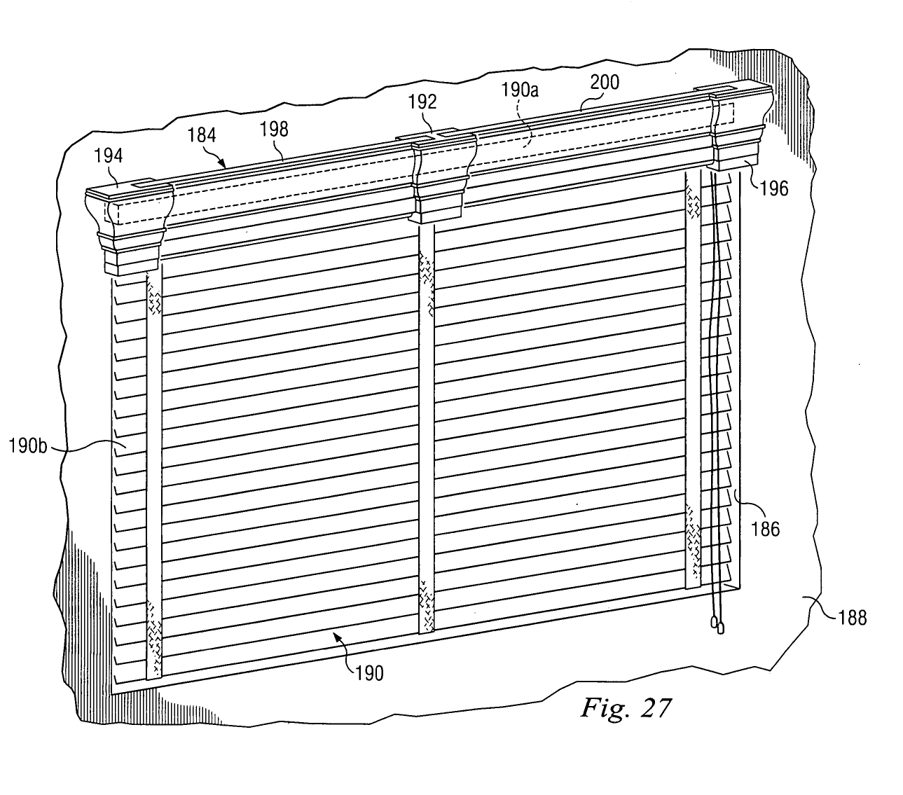

Referring to FIGS. 27-28, another embodiment of a furnishing accessory, in the form of a valance board, is generally referred to by the reference numeral 184. A window 186 is formed in a wall 188, and a window-blinds assembly 190 is disposed in the window and includes a headrail 190a and blinds 190b extending downward therefrom. The valance board 184 is connected to the headrail 190a in a conventional manner. In an exemplary embodiment, the valance board 184 may be generally flush mounted against the headrail 190a using, for example, one or more clips, fasteners and/or any combination thereof.

The valance board 184 includes a joint element 192 that is disposed between joint elements or endcaps 194 and 196. A design element 198 extends between and is engaged with the endcap 194 and the joint element 192, and a design element 200 extends between and is engaged with the endcap 196 and the joint element 192. The aspects and features of the joint element 192, the endcaps 194 and 196, the design elements 192 and 194, and the various engagements therebetween, are similar to the above-described aspects and features of the joint element 52, the protrusions 26 and 26′, the design elements 54 and 56, and the various engagements therebetween, respectively, of the embodiment of FIGS. 7-8, and therefore will not be described in detail. The design elements 198 and 200 extend in a generally vertical direction.

Any of the above-described furnishing-accessory embodiments and components thereof may be composed of any suitable material, and/or any material suitable for cutting with a cutting tool, such as, for example, polyurethane, metal, wood, foam, alloy, rubber, plastic materials or any combination thereof. Also, any of the above-described furnishing-accessory embodiments and components thereof may be composed of any material suitable for molding such as, for example, any polyurethane material.

It is understood that variations may be made in the foregoing without departing from the scope of the disclosure. For example, besides being in the form of cornice boxes, valance boards, mantels and/or window sills, other forms of furnishing accessories according to the present disclosure include but are not limited to shelving units, storage units, curios and other accents. Also, furnishing accessories according to the present disclosure are not limited to home-furnishing accessories or wall accessories. Correspondingly, design elements for use with furnishing accessories according to the present disclosure are not limited to valances or shelves.

Further, it is understood that a wide variety of steps may be employed to assemble and/or install one or more of the above-described furnishing-accessory embodiments. For example, L-shaped or other mounting brackets may be used to connect an endcap or column to a wall. Moreover, in several exemplary embodiments, a support structure such as, for example, one or more rods, may be connected to a wall and used to support one or more of the above-described furnishing accessories. The one or more support rods may be connected to the wall, and may include one or more, flexible sections or portions to accommodate any angles associated with the structure of the furnishing accessory to be supported such as, for example, the angles defined by the protrusions 24 and 26 of the endcap 18, and the protrusions 24′ and 26′ of the endcap 20, of the cornice box 10. Also, one or more hooks may extend from one or more of the above-described furnishing accessories and engage and/or hook onto one or more rods that are connected to a wall so that the rods may support the furnishing accessories.

Still further, in addition to the decorative profiles described above and depicted in the corresponding figures, it is understood that the surfaces of the parts of the above-described furnishing-accessory embodiments may define a wide variety of decorative profiles, including profiles that are plain, relatively unadorned and/or considered to be non-decorative. Also, the above-described measurement markings may be applied to the corresponding design elements in a wide variety of ways such as, for example, by printing, forming, etching, sticking on with labels, pasting, drawing or any combination thereof.

Still further, the joint elements 74 and/or 76 may be modified to accommodate external angles, such as external right angles, in rooms or other spaces, rather than only accommodating internal angles as shown in FIGS. 9-11D. For example, in such a modification with respect to the joint element 74 shown in FIG. 11C, pockets similar to the pockets 74g and 74h would be formed in the protrusion 74a, and the protrusions 74b and 74c would be modified so that the surfaces 74i and 74j would be able to engage a pair of walls defining an external angle dependent upon the angle 72a, that is, with the value of the external angle being substantially equal to the difference between 360 degrees and the value of the angle 72a which, for example and as shown in FIG. 11C, is about 120 degrees, thereby resulting in the value of the external angle being about 240 degrees.

Moreover, it is understood that the endcaps, design elements, joint elements, columns and/or other components of the above-described furnishing-accessory embodiments may be integrally formed as single, unitary pieces such as, for example, molded pieces, and/or may be assemblies.

Any foregoing spatial references, such as “upper,” “lower,” “above,” “below,” “rear,” “between,” “vertical,” “angular,” etc., are for the purpose of illustration only and do not limit the specific orientation or location of the structure described above.

In several exemplary embodiments, it is understood that one or more of the operational steps in each embodiment may be omitted. Moreover, in some instances, some features of the present disclosure may be employed without a corresponding use of the other features.

It is understood that one or more of the above-described embodiments and/or variations may be combined in whole or in part with any one or more of the other above-described embodiments and/or variations.

Although exemplary embodiments of this invention have been described in detail above, those skilled in the art will readily appreciate that many other modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents, but also equivalent structures.

What is claimed is:

1. A joint element for use with a design element to form a furnishing accessory, the joint element comprising a protrusion defining first and second surfaces wherein the first surface defines a profile, and a pocket disposed in the protrusion for at least partially receiving the design element, the pocket having an opening in the second surface by which the design element is at least partially received.

2. The joint element of claim 1 wherein at least a portion of the profile defined by the first surface corresponds to at least a portion of a profile defined by a surface of the design element so that the portions appear to be continuous when the design element is at least partially received by the pocket.

3. The joint element of claim 2 wherein a round extends from the first surface to the second surface to further promote the appearance of continuity between the portions.

4. The joint element of claim 1 wherein at least a portion of the cross-section of the pocket corresponds to at least a portion of the cross-section of the design element so that, when the design element is at least partially received by the pocket, the correspondence between the portions prevents relative movement between the joint element and the design element in a direction that is substantially perpendicular to the direction of receipt of the design element.

5. The joint element of claim 1 wherein the joint element is adapted to slidably engage the design element.

6. The joint element of claim 1 further comprising a second protrusion extending from the first-mentioned protrusion.

7. The joint element of claim 6 wherein the protrusions define a continuous horizontal surface.

8. The joint element of claim 6 further comprising a cavity formed in the second protrusion, the cavity defining at least one surface with which a rod is engageable.

9. The joint element of claim 6 further comprising an external recess formed in at least one of the first and second protrusions for receiving and at least partially capturing a panel.

10. The joint element of claim 6 wherein the second protrusion defines a rear surface and further comprising means associated with the rear surface for engaging at least one member extending from a wall.

11. The joint element of claim 10 wherein the engaging means comprises a bracket disposed in a slot formed in the rear surface, the bracket having at least one keyhole slot formed therein.

12. The joint element of claim 6 wherein the design element is in the form of a valance and wherein the furnishing accessory is in the form of a cornice box.

13. The joint element of claim 1 wherein the protrusion defines a third surface opposing the second surface, and further comprising a second pocket disposed in the protrusion for at least partially receiving a second design element, the second pocket having an opening in the third surface by which the second design element is at least partially received.

14. The joint element of claim 13 wherein the profile defined by the first surface corresponds to a profile defined by a surface of the first-mentioned design element; and
wherein the profile defined by the first surface corresponds to a profile defined by a surface of the second design element.

15. The joint element of claim 13 wherein the joint element is adapted to slidably engage the second design element.

16. The joint element of claim 1 further comprising:
a second protrusion extending from the first protrusion to define a predetermined angle; and
a second pocket disposed in the second protrusion for at least partially receiving a second design element.

17. The joint element of claim 16 wherein the profile defined by the first surface corresponds to a profile defined by a surface of the first-mentioned design element; and
wherein a profile defined by a surface of the second protrusion corresponds to a profile defined by a surface of the second design element.

18. The joint element of claim 16 wherein the joint element is adapted to slidably engage the second design element.

19. The joint element of claim 16 further comprising a third protrusion extending from the first and second protrusions, the third protrusion defining angularly-spaced first and second rear surfaces wherein the angular spacing is supplementary to the predetermined angle.

20. The joint element of claim 19 wherein the predetermined angle is substantially equal to an angle defined by the angular spacing between two walls.

21. The joint element of claim 20 wherein the two walls form a portion of a bay window arrangement;
wherein each of the first-mentioned and second design elements is in the form of a valance; and
wherein the furnishing accessory is in the form of a cornice box.

22. The joint element of claim 1 wherein the design element is in the form of a shelf and the furnishing accessory is in the form of a mantel.

23. The joint element of claim 1 further comprising:
a second protrusion extending from the first protrusion; and
a second pocket disposed in the second protrusion for receiving a column.

24. The joint element of claim 23 wherein the furnishing accessory is in the form of a mantel.

25. The joint element of claim 24 wherein the joint element is sized to partially frame a fireplace unit.

26. The joint element of claim 1 wherein the design element is in the form of a shelf and the furnishing accessory is in the form of a window sill.

27. The joint element of claim 1 further comprising another protrusion extending from the first-mentioned protrusion, the another protrusion comprising an opening through which a rod is adapted to extend.

28. A design element for use with first and second joint elements to form a furnishing accessory, the design element comprising a protrusion having first and second end portions, the first and second end portions adapted to be at least partially received by pockets formed in the first and second joint elements, respectively, so that the design element extends between the first and second joint elements.

29. The design element of claim 28 wherein the protrusion defines a surface having a plurality of measurement markings to indicate the length of the design element.

30. The design element of claim 29 wherein the length of the design element may be reduced by removing a portion of the protrusion.

31. The design element of claim 28 wherein the design element is adapted to slidably engage the first and second joint elements.

32. The design element of claim 28 further comprising an external recess formed in the protrusion for receiving and at least partially capturing a panel.

33. The design element of claim 28 wherein the design element is in the form of a valance and wherein the furnishing accessory is in the form of a cornice box.

34. The design element of claim 28 wherein the design element is in the form of a shelf.

35. The design element of claim 34 wherein the furnishing accessory is in a form selected from the group consisting of a mantel and a window sill.

36. The design element of claim 28 wherein at least a portion of a profile defined by a surface of the protrusion corresponds to at least a portion of a profile defined by a surface of one of the first and second joint elements so that the portions appear to be continuous when the design element is at least partially received by the pocket of the one of the first and second joint elements.

37. The design element of claim 36 wherein at least a portion of the profile defined by the surface of the protrusion corresponds to at least a portion of a profile defined by a surface of the other of the first and second joint elements so that the portions appear to be continuous when the design element is at least partially received by the pocket of the other of the first and second joint elements.

38. The design element of claim 28 further comprising a bracket slidably engaged with the protrusion wherein the bracket defines at least one edge that is substantially perpendicular to the length of extension of the design element, the edge facilitating the application of a marking to the protrusion.

39. The design element of claim 38 wherein the protrusion defines a surface having a plurality of measurement markings to indicate the length of the design element.

40. The design element of claim 38 wherein at least one groove is formed in a surface of the protrusion and extends at least partially along the length of the protrusion, and wherein the bracket comprises at least one projection that extends into the groove to control the direction of relative movement between the bracket and the protrusion.

41. The design element of claim 40 wherein the groove and the projection are each V-shaped.

42. The design element of claim 38 wherein the bracket clamps over the protrusion to control the direction of relative movement between the bracket and the protrusion.

43. A furnishing accessory comprising:
a design element; and
spaced first and second joint elements, each joint element comprising:
a protrusion defining first and second surfaces wherein the first surface defines a profile, and
a pocket disposed in the protrusion, the pocket having an opening in the second surface;
wherein the design element is at least partially received by the pocket of at least one of the first and second joint elements.

44. The furnishing accessory of claim 43 wherein the design element is slidably engaged with the at least one of the first and second joint elements.

45. The furnishing accessory of claim 43 wherein at least a portion of the profile defined by the first surface of the at least one of the first and second joint elements corresponds to at least a portion of a profile defined by a surface of the design element so that the portions appear to be continuous.

46. The furnishing accessory of claim 45 wherein a round extends from the first surface to the second surface of the at least one of the first and second joint elements to further promote the appearance of continuity between the portions.

47. The furnishing accessory of claim 43 wherein the design element is at least partially received by the pocket of the other of the first and second joint elements so that the design element extends between the first and second joint elements.

48. The furnishing accessory of claim 47 wherein the design element is slidably engaged with the first and second joint elements.

49. The furnishing accessory of claim 47 wherein the design element is in the form of a valance and wherein the furnishing accessory is in the form of a cornice box.

50. The furnishing accessory of claim 47 further comprising:
first and second external recesses formed in the first and second joint elements, respectively;
a third external recess formed in the design element; and
a panel received by the first, second and third external recesses so that the panel extends between the first and second joint elements and is at least partially captured by one or more of the first, second and third the external recesses.

51. The furnishing accessory of claim 47 wherein the design element is in the form of a shelf.

52. The furnishing accessory of claim 51 wherein the furnishing accessory is in a form selected from the group consisting of a mantel and a window sill.

53. The furnishing accessory of claim 47 wherein each joint element further comprises a second protrusion extending from the first protrusion and a second pocket disposed in the second protrusion;
wherein the furnishing accessory further comprises a column slidably engaged with each second pocket of each joint element so that the columns are in a spaced, parallel relation.

54. The furnishing accessory of claim 53 further comprising:
a base spaced from the design element; and
first and second pockets formed in the base and slidably engaged with the columns, respectively.

55. The furnishing accessory of claim 53 wherein the furnishing accessory is sized to frame a fireplace unit.

56. The furnishing accessory of claim 43 further comprising:
a third joint element disposed between the first and second joint elements, the third joint element comprising:
a protrusion defining first, second and third surfaces wherein the first surface defines a profile;
a first pocket formed in the second surface; and
a second pocket disposed in the protrusion, the second pocket having an opening in the third surface;
and
a second design element at least partially received by the first pocket of the third joint element and at least partially received by the pocket of the second joint element so that the second design element extends between the third and second joint elements;
wherein the first-mentioned design element is at least partially received by the second pocket of the third joint element so that the first-mentioned design element extends between the first and third joint elements.

57. The furnishing accessory of claim 56 wherein the profile defined by the first surface of the third joint element corresponds to the profile defined by the surface of the first-mentioned design element and to a profile defined by a surface of the second design element so that the profiles appear to be continuous.

58. The furnishing accessory of claim 56 wherein the first-mentioned design element is slidably engaged with the first and third joint elements; and
wherein the second design element is slidably engaged with the second and third joint elements.

59. The furnishing accessory of claim 56 wherein the design elements are in the form of valances and the furnishing accessory is in the form of a cornice box.

60. The furnishing accessory of claim 43 wherein at least one of the first and second joint elements further comprises:
a second protrusion extending from the first-mentioned protrusion to define a corner, and
a cavity formed in the second protrusion;
wherein the furnishing accessory further comprises a rod engaged with a surface defined by the cavity.

61. The furnishing accessory of claim 43 wherein the design element defines a surface having a plurality of measurement markings to indicate the length of the design element.

62. The furnishing accessory of claim 43 further comprising a bracket slidably engaged with the design element wherein the bracket defines at least one edge that facilitates the application of a marking to the design element for reducing the length thereof.

63. The furnishing accessory of claim 43 wherein at least one of the first and second joint elements further comprises means for engaging at least one member extending from a wall.

64. The furnishing accessory of claim 43 wherein at least one of the first and second joint elements further comprises:
a second protrusion extending from the first protrusion to define a predetermined angle that is substantially equal to an angle defined by the angular spacing between two walls of a bay window arrangement; and
a third protrusion extending from the first and second protrusions, the third protrusion defining angularly-spaced first and second rear surfaces wherein the angular spacing is supplementary to the predetermined angle.

65. The furnishing accessory of claim 43 wherein each of the first and second joint elements further comprises:
another protrusion extending from the first-mentioned protrusion; and
an opening in the another protrusion;
wherein the openings in the respective another protrusions are axially aligned; and
wherein the furnishing accessory further comprises a rod extending through the axially-aligned openings in the respective another protrusions.

66. The furnishing accessory of claim 43 wherein the furnishing accessory is in the form of a valance board.

67. A kit comprising:
at least one grommet; and
at least one pilot member, the pilot member comprising a head and an extension portion extending therefrom and adapted to extend through the grommet;
wherein the head of the pilot member is sized so that the head is permitted to pass through the increased-diameter portion of a keyhole slot associated with a surface of a joint element of a furnishing accessory and so that the head is prevented from passing through the slot portion of the keyhole slot; and
wherein the grommet has:
a first configuration in which:
the extension portion of the pilot member extends through the grommet; and
the grommet is adjustably spaced from the head of the pilot member to permit relative movement between the pilot member and the keyhole slot when the extension portion of the pilot member extends through the slot portion of the keyhole slot; and
a second configuration in which:
the extension portion of the pilot member extends through the grommet; and
an end of the grommet bears against material surrounding the keyhole slot to substantially prevent relative movement between the pilot member and the keyhole slot.

68. The kit of claim 67 wherein the pilot member further comprises a plurality of ribs extending from the head to facilitate the substantial prevention of relative movement between the pilot member and the keyhole slot.

69. The kit of claim 67 wherein the head of the pilot member comprises a circumferentially-extending knurled surface to facilitate the adjustment of the spacing between the grommet and the head of the pilot member.

70. The kit of claim 67 wherein the grommet has a third configuration in which:
the extension portion of the pilot member extends through the grommet;
the end of the grommet bears against the material surrounding the keyhole slot to substantially prevent relative movement between the pilot member and the keyhole slot; and
another end of the grommet bears against a wall.

71. The kit of claim 70 wherein, when the grommet is in its third configuration, a distal end of the extension portion of the pilot member extends beyond the another end of the grommet to form a pilot indentation in the wall.

72. The kit of claim 71 wherein the extension portion of the pilot member comprises a plurality of grooves so that, when the grommet is in its third configuration, the plurality of grooves forms an imprint in the wall.

73. The kit of claim 71 further comprising at least one installation member wherein the installation member is adapted to engage the wall at a location substantially corresponding to the location of the pilot indentation.

74. The kit of claim 71 wherein the installation member is adapted to extend through the slot portion of the keyhole slot to support the joint element when the installation member is engaged with the wall.

75. The kit of claim 74 further comprising a bracket in which the keyhole slot is formed, the bracket adapted to be disposed in a slot formed in the surface of the joint element.

76. The kit of claim 71 further comprising the joint element.

77. The kit of claim 76 further comprising a design element adapted to slidably engage the joint element.

78. The kit of claim 77 further comprising a second joint element adapted to be spaced from the first-mentioned joint element by a predetermined spacing.

79. The kit of claim 78 further comprising:
at least one other grommet; and
at least one other pilot member, the one other pilot member comprising a head and an extension portion extending therefrom and adapted to extend through the one other grommet;
wherein the head of the one other pilot member is sized so that the head is permitted to pass through the increased-diameter portion of a second keyhole slot associated with a surface of the second joint element, and so that the head is prevented from passing through the slot portion of the second keyhole slot; and
wherein the one other grommet has:
a first configuration in which:
the extension portion of the one other pilot member extends through the one other grommet; and
the one other grommet is adjustably spaced from the head of the one other pilot member to permit relative movement between the one other pilot member and the second keyhole slot when the extension portion of the one other pilot member extends through the slot portion of the second keyhole slot;
a second configuration in which:
the extension portion of the one other pilot member extends through the one other grommet; and
an end of the one other grommet bears against material surrounding the second keyhole slot to substantially prevent relative movement between the one other pilot member and the one other keyhole slot; and
a third configuration in which:
the extension portion of the one other pilot member extends through the one other grommet;
the end of the one other grommet bears against the material surrounding the second keyhole slot to substantially prevent relative movement between the one other pilot member and the one other keyhole slot; and
another end of the one other grommet bears against the wall.

80. The kit of claim 79 wherein, when the one other grommet is in its third configuration, the distal end of the extension portion of the one other pilot member extends beyond the another end of the one other grommet and is adapted to form a second pilot indentation in the wall.

81. The kit of claim 80 wherein the distance between the first-mentioned and second pilot indentations is substantially equal to the distance between the first-mentioned and second keyhole slots.

82. A furnishing-accessory kit comprising:
first and second joint elements adapted to be spaced from each other by a predetermined spacing, each joint element comprising:
a protrusion defining first and second surfaces wherein the first surface defines a profile; and
a pocket disposed in the protrusion, the pocket having an opening in the second surface; and
a design element adapted to be slidably engaged with the pocket of at least one of the first and second joint elements.

83. The furnishing-accessory kit of claim 82 wherein at least a portion of the profile defined by the first surface of the at least one of the first and second joint elements corresponds to at least a portion of a profile defined by a surface of the design element so that the portions appear to be continuous when the design element is slidably engaged with the pocket of the at least one of the first and second joint elements.

84. The furnishing-accessory kit of claim 83 wherein a round extends from the first surface to the second surface of the at least one of the first and second joint elements to further promote the appearance of continuity between the portions when the design element is slidably engaged with the pocket of the at least one of the first and second joint elements.

85. The furnishing-accessory kit of claim 82 wherein the design element is adapted to be slidably engaged with the pocket of the other of the first and second joint elements so that the design element extends between the first and second joint elements.

86. The furnishing-accessory kit of claim 85 wherein the design element is in the form of a valance and wherein the furnishing accessory is in the form of a cornice box.

87. The furnishing-accessory kit of claim 85 wherein the design element is in the form of a shelf.

88. The furnishing-accessory kit of claim 87 wherein the furnishing accessory is in a form selected from the group consisting of a mantel and a window sill.

89. The furnishing-accessory kit of claim 85 wherein each joint element further comprises a second protrusion extending from the first protrusion and a second pocket disposed in the second protrusion; and
wherein the furnishing-accessory kit further comprises first and second columns adapted to be slidably engaged with the second pockets of the first and second joint elements, respectively, so that the columns are in a spaced, parallel relation.

90. The furnishing-accessory kit of claim 89 further comprising:
a base adapted to be spaced from the design element; and
first and second pockets formed in the base and adapted to be slidably engaged with the columns, respectively.

91. The furnishing accessory of claim 89 wherein the furnishing accessory is sized to frame a fireplace unit.

92. The furnishing-accessory kit of claim 82 further comprising:
a third joint element adapted to be disposed between the first and second joint elements, the third joint element comprising:
a protrusion defining first, second and third surfaces wherein the first surface defines a profile,
a first pocket formed in the second surface, and
a second pocket disposed in the protrusion, the second pocket having an opening in the third surface, and
a second design element adapted to be slidably engaged with the first pocket of the third joint element and adapted to be slidably engaged with the pocket of the second joint element so that the second design element extends between the third and second joint elements when the second design element is slidably engaged with the third and second joint elements;
wherein the first-mentioned design element is adapted to be slidably engaged with the second pocket of the third joint element so that the first-mentioned design element extends between the first and third joint elements when the first-mentioned design element is slidably engaged with the first and third joint elements.

93. The furnishing-accessory kit of claim 82 wherein the design element defines a surface having a plurality of measurement markings to indicate the length of the design element.

94. The furnishing-accessory kit of claim 82 further comprising a bracket adapted to slidably engage the design element wherein the bracket defines at least one edge that is adapted to facilitate the application of a marking to the design element for reducing the length thereof.

95. The furnishing-accessory kit of claim 82 wherein at least one of the first and second joint elements further comprises means for engaging at least one member extending from a wall.

96. The furnishing-accessory kit of claim 82 further comprising means engageable with a wall and engageable with at least one of the first and second joint elements for supporting same.

97. The furnishing-accessory kit of claim 82 wherein each joint element further comprises an external recess;
wherein the design element comprises an external recess; and
wherein the kit further comprises a panel adapted to be received and at least partially captured by the external recesses of the joint elements and the external recess of the design element.

98. The furnishing-accessory kit of claim 82 wherein each of the first and second joint elements further comprises:
another protrusion extending from the first-mentioned protrusion; and
an opening in the another protrusion; and
wherein the furnishing-accessory kit further comprises a rod adapted to extend through the openings in the respective another protrusions.

99. A method of assembling a furnishing accessory, the method comprising:
inserting an end portion of a design element into a pocket formed in a surface of a first joint element so that the design element is slidably engaged with the joint element; and
inserting another end portion of the design element into a pocket formed in a surface of a second joint element so that the design element is slidably engaged with the second joint element.

100. The method of claim 99 wherein at least a portion of a profile defined by the design element corresponds to at least portions of profiles defined by each of the joint elements so that the portions appear to be continuous.

101. The method of claim 99 wherein the design element is in the form of a valance and the furnishing accessory is in the form of a cornice box.

102. The method of claim 99 wherein the design element is in the form of a shelf and the furnishing accessory is in a form selected from the group consisting of a mantel and a window sill.

103. The method of claim 99 further comprising engaging the first and second joint elements with a wall to support the furnishing accessory.

104. The method of claim 99 further comprising spacing a third joint element from the second joint element;
inserting an end portion of a second design element into a second pocket disposed in the second joint element so that the second design element is slidably engaged with the second joint element; and
inserting another end portion of the second design element into a pocket formed in the third joint element so that the second design element is slidably engaged with the second joint element.

105. The method of claim 104 further comprising engaging the first and third joint elements with a wall to support the furnishing accessory.

106. The method of claim 104 wherein at least portions of profiles defined by the design elements correspond to at least portions of profiles defined by the joint elements so that that the portions appear to be continuous.

107. The method of claim 99 wherein the design element defines a surface having a plurality of measurement markings to indicate the length of the design element.

108. The method of claim 99 further comprising slidably engaging a bracket with the design element; and
applying a marking to the design element wherein the marking is at least partially defined by an edge of the bracket.

109. The method of claim 108 further comprising reducing the length of the design element wherein the amount of the reduction corresponds to the marking.

110. A method of installing a furnishing accessory, the method comprising:
providing a pilot member comprising a head and an extension portion extending therefrom;
extending the extension portion of the pilot member through a grommet;
passing the head of the pilot member through the increased-diameter portion of a keyhole slot associated with a surface of a joint element of the furnishing accessory;
moving the pilot member so that the extension portion of the pilot member extends through the slot portion of the keyhole slot; and
moving the grommet along the extension portion of the pilot member so that an end of the grommet bears against material surrounding the keyhole slot to prevent relative movement between the pilot member and the keyhole slot.

111. The method of claim 110 further comprising moving the joint element towards a wall until another end of the grommet bears against the wall.

112. The method of claim 111 wherein the distal end of the extension portion extends beyond the another end of the grommet and forms a pilot indentation in the wall when the another end of the grommet bears against the wall.

113. The method of claim 112 further comprising engaging an installation member with the wall at a location corresponding to the pilot indentation.

114. The method of claim 113 further comprising extending the installation member through the slot portion of the keyhole slot to support the joint element.

115. The method of claim 110 further comprising inserting an end portion of a design element into a pocket formed in a second surface of the joint element so that the design element is slidably engaged with the joint element; and
spacing a second joint element from the first-mentioned joint element by a predetermined spacing.

116. The method of claim 115 further comprising providing a second pilot member comprising a head and an extension portion extending therefrom;
extending the extension portion of the second pilot member through a second grommet;
passing the head of the second pilot member through the increased-diameter portion of a second keyhole slot associated with a second surface of the second joint element;
moving the second pilot member so that the extension portion of the second pilot member extends through the slot portion of the second keyhole slot; and
moving the second grommet along the extension portion of the second pilot member so that an end of the second grommet bears against material surrounding the second keyhole slot to prevent relative movement between the second pilot member and the second keyhole slot.

117. The method of claim 116 further comprising moving the joint elements towards a wall while maintaining the predetermined spacing until another end of each grommet bears against the wall;
wherein the distal end of the extension portion of each pilot member extends beyond the another end of the corresponding grommet and forms a pilot indentation in the wall when the another end of the corresponding grommet bears against the wall; and
wherein the spacing between the pilot indentations is substantially equal to the spacing between the keyhole slots.

118. The method of claim 117 further comprising engaging an installation member with the wall at a location corresponding to each pilot indentation; and
extending the installation members through the respective ones of the slot portions of the keyhole slots to support the respective ones of the joint elements.

119. The method of claim 118 further comprising inserting another end portion of the design element into a pocket formed in the second joint element so that the design element is slidably engaged with the second joint element.

120. The method of claim 119 wherein the design element is in the form of a valance and the furnishing accessory is in the form of a cornice box.

121. The method of claim 119 wherein the design element is in the form of a shelf and the furnishing accessory is in a form selected from the group consisting of a mantel and a window sill.

122. A furnishing accessory comprising:
a design element having first and second pockets formed therein; and
first and second columns slidably engaged with the first and second pockets, respectively.

123. The furnishing accessory of claim 122 further comprising a base having first and second pockets formed therein, the first and second columns being slidably engaged with the first and second pockets of the base, respectively.

124. The furnishing accessory of claim 122 wherein the design element is in the form of a shelf and the furnishing accessory is in the form of a mantel.

125. The furnishing accessory of claim 124 wherein the furnishing accessory is sized to frame a fireplace unit.

126. A joint element for use with a design element to form a furnishing accessory, the joint element comprising:
a protrusion defining first and second surfaces wherein the first surface defines a profile; and
a pocket disposed in the protrusion, the pocket having an opening in the second surface for receiving the design element whereby the design element slidably engages the joint element;
wherein at least a portion of the profile defined by the first surface corresponds to at least a portion of a profile defined by a surface of the design element so that the portions appear to be continuous when the design element is received by the pocket;
wherein a round extends from the first surface to the second surface to further promote the appearance of continuity between the portions; and
wherein at least a portion of the cross-section of the pocket corresponds to at least a portion of the cross-section of the design element so that, when the design element is received by the pocket, the correspondence between the portions prevents relative movement between the joint element and the design element in a direction that is substantially perpendicular to the direction of receipt of the design element.

127. A design element for use with first and second joint elements to form a furnishing accessory, the design element comprising a protrusion having first and second end portions, the first and second end portions adapted to be slidably engaged with pockets formed in the first and second joint elements, respectively, so that the design element extends between the first and second joint elements when slidably engaged therewith;
wherein the length of the design element may be reduced by removing a portion of the protrusion;
wherein at least a portion of a profile defined by a surface of the protrusion corresponds to at least a portion of a profile defined by a surface of one of the first and second joint elements so that the portions appear to be continuous when the design element is received by the pocket of the one of the first and second joint elements;
wherein at least a portion of the profile defined by the surface of the protrusion corresponds to at least a portion of a profile defined by a surface of the other of the first and second joint elements so that the portions appear to be continuous when the design element is received by the pocket of the other of the first and second joint elements; and
wherein the protrusion defines a surface having a plurality of measurement markings to indicate the length of the design element.

128. A furnishing accessory comprising:
spaced first and second joint elements, each joint element comprising:
a protrusion defining first and second surfaces wherein the first surface defines a profile, and
a pocket disposed in the protrusion, the pocket having an opening in the second surface;
and
a design element extending between the first and second joint elements and slidably engaged with the pockets of the first and second joint elements;
wherein at least a portion of the profile defined by the first surface of the at least one of the first and second joint elements corresponds to at least a portion of a profile defined by a surface of the design element so that the portions appear to be continuous; and
wherein a round extends from the first surface to the second surface of the at least one of the first and second joint elements to further promote the appearance of continuity between the portions.

129. A kit comprising:
at least one grommet; and
at least one pilot member, the pilot member comprising a head and an extension portion extending therefrom and adapted to extend through the grommet;
wherein the head of the pilot member is sized so that the head is permitted to pass through the increased-diameter portion of a keyhole slot associated with a surface of a joint element of a furnishing accessory and so that the head is prevented from passing through the slot portion of the keyhole slot;
wherein the grommet has:
a first configuration in which:
the extension portion of the pilot member extends through the grommet; and
the grommet is adjustably spaced from the head of the pilot member to permit relative movement between the pilot member and the keyhole slot when the extension portion of the pilot member extends through the slot portion of the keyhole slot;
a second configuration in which:
the extension portion of the pilot member extends through the grommet; and
an end of the grommet bears against material surrounding the keyhole slot to substantially prevent relative movement between the pilot member and the keyhole slot; and
a third configuration in which:
the extension portion of the pilot member extends through the grommet;
the end of the grommet bears against the material surrounding the keyhole slot to substantially prevent relative movement between the pilot member and the keyhole slot; and
another end of the grommet bears against a wall; and
wherein, when the grommet is in its third configuration, a distal end of the extension portion of the pilot member extends beyond the another end of the grommet to form a pilot indentation in the wall.
